(19) United States
(12) Patent Application Publication
(10) Pub. No.: US 2026/0070666 A1
(43) Pub. Date: Mar. 12, 2026

(54) AIRCRAFT WITH AN UNDUCTED FAN PROPULSOR

(71) Applicant: General Electric Company, Evendale, OH (US)

(72) Inventors: Sara Elizabeth Carle, Columbus, OH (US); Daniel L. Tweedt, West Chester, OH (US); Syed Arif Khalid, West Chester, OH (US); Andrew Breeze-Stringfellow, Montgomery, OH (US); William Bowden, Cleves, OH (US)

(21) Appl. No.: 19/387,166

(22) Filed: Nov. 12, 2025

Related U.S. Application Data
(63) Continuation-in-part of application No. PCT/US2024/040754, filed on Aug. 2, 2024.
Application No. PCT/US2024/040754 is a continuation-in-part of application No. 18/652,052, filed on May 1, 2024, now Pat. No. 12,384,522.
Application No. 18/652,052 is a continuation-in-part of application No. 18/230,609, filed on Aug. 4, 2023, now Pat. No. 12,365,471.

(51) Int. Cl. B64D 27/12; B64C 11/18; B64C 11/48

(52) U.S. Cl. CPC B64D 27/12; B64C 11/18; B64C 11/48

(57) ABSTRACT

The present disclosure is generally related to aircraft having one or more unducted fan propulsors at locations within specific regions relative to an airfoil, such as a wing or horizontal stabilizer. More specifically, the specific regions are located where there is a relatively higher pressure air flow beneath the wings or above a horizontal stabilizer. That higher pressure air flow can be utilized to provide increased thrust from the unducted fan propulsor.

### CROSS-REFERENCE TO RELATED APPLICATION

This application is a continuation-in-part of International Appl. No. PCT/US2024/040754, filed Aug. 2, 2024, which claims priority to U.S. patent application Ser. No. 18/230,609, filed on Aug. 4, 2023, and Ser. No. 18/652,052, filed May 1, 2024, the latter of which is a continuation-in-part of the former, the disclosures of which are hereby incorporated by reference in their entireties.

### FIELD

The present disclosure relates generally to an aircraft with a fan propulsor.

### BACKGROUND

Winged aircraft have undermounted propulsors in the form of a turboprop engine. The addition of a propulsor to a wing can lead to installation penalties, including increased drag. As the size of the undermounted propulsor increases, installation penalties can also increase, such as increased weight.

### BRIEF DESCRIPTION OF THE DRAWINGS

A full and enabling disclosure of the aspects of the present description, including the best mode thereof, directed to one of ordinary skill in the art, is set forth in the specification, which refers to the appended figures, in which:

FIG. 1 comprises a top plan view of an aircraft as configured in accordance with various embodiments of these teachings, with undermounted, unducted fan propulsors mounted on forward wings of the aircraft;

FIG. 2 comprises a top plan view of an aircraft as configured in accordance with various embodiments of these teachings, with unducted fan propulsors mounted on top of horizontal stabilizers of the aircraft;

FIG. 3 comprises an elevational cross-sectional view of an exemplary unducted fan propulsor having a plurality of blades arranged in a forward array and a rearward array;

FIG. 4 comprises a schematic side elevation view showing the location of the unducted fan propulsor of FIG. 3 relative to an airfoil section;

FIG. 5A is a schematic side elevation view similar to FIG. 4 and showing the unducted fan propulsor pitched downward relative to the airfoil section;

FIG. 5B defines a pitch angle Φ for the unducted fan propulsor relative to a chord line of the airfoil section in FIG. 4;

FIG. 6A comprises a top plan view of the propulsor of FIG. 4 and inboard and outboard locations of the wing relative to an unducted fan propulsor centerline, with the inboard and outboard locations in FIG. 6A used to determine a chord length (C) of the airfoil section in FIG. 4;

FIG. 6B comprises a schematic side elevation view of a first section and a second section of the aircraft wing, which sections are used to determine an effective quarter chord point (QC) of the airfoil section in FIG. 4;

FIG. 6C comprises a schematic top plan view of a portion of an aircraft having a pair of wings extending from the fuselage with the propulsor of FIG. 3 mounted relative to each of the wings;

FIG. 6D comprises a schematic front elevation view of the aircraft portion of FIG. 6C;

FIG. 6E comprises a schematic top plan view of a portion of an aircraft having a pair of wings extending from the fuselage with the propulsor of FIG. 3 mounted relative to each of the wings, similar to FIG. 6C but showing the propulsors toed inwardly toward the fuselage;

FIG. 7 comprises a schematic side elevation view similar to that of FIG. 4, but showing a first ellipse, a second ellipse, a third ellipse, and a fourth ellipse to illustrate various embodiments of mounting locations of one of the unducted fan propulsors relative to one of the wings;

FIG. 8 comprises a schematic side elevation view similar to that of FIG. 7, but showing a first ellipse, a second ellipse, a third ellipse, and a fourth ellipse to illustrate various embodiments of mounting locations of one of the unducted fan propulsors relative to one of the horizontal stabilizers;

FIG. 9 comprises a schematic side elevation view similar to that of FIG. 7, showing the first ellipse, the second ellipse, the third ellipse, and the fourth ellipse to illustrate various embodiments of mounting locations of one of the unducted fan propulsors relative to one of the wings;

FIG. 10 comprises a schematic side elevation view similar to that of FIG. 8, showing the first ellipse, the second ellipse, the third ellipse, and the fourth ellipse to illustrate various embodiments of mounting locations of one of the unducted fan propulsors relative to one of the horizontal stabilizers; and

FIG. 11 comprises a schematic representation showing exemplary locations of a point P of one of the unducted fan propulsors, as defined herein, within the first ellipse, the second ellipse, the third ellipse, and the fourth ellipse.

FIG. 12 depicts a front elevation view of the rearward array of vanes taken from line 2-2 of FIG. 3, simplified to omit internal details of the open fan engine.

FIG. 13 is a cross-section view of a vane of the rearward array, taken along line 3-3 of FIG. 27, showing a mean camber line (MCL) and a leading edge angle (LEA) for an open fan engine with the blades of the forward array arranged for clockwise rotation.

FIG. 14 is a cross-section view of a vane of the rearward array, similar to that of FIG. 13, but showing the leading edge angle (LEA) being the same as an average leading edge angle (ALEA).

FIG. 15 is a cross-section view of a vane of the rearward array, similar to that of FIG. 13 but showing an example of a leading edge angle (LEA) being less than the average leading edge angle (ALEA) and achieved by varying the stagger of the blade.

FIG. 16 is a cross-section view of a vane of the rearward array, similar to that of FIG. 13 but showing an example of a leading edge angle (LEA) being less than the average leading edge angle (ALEA) and achieved by varying the camber of the blade.

FIG. 17 is a cross-section view of a vane of the rearward array, similar to that of FIG. 13 but showing an example of a leading edge angle (LEA) being greater than the average leading edge angle (ALEA) and achieved by varying the stagger of the blade.

FIG. 18 is a cross-section view of a vane of the rearward array, similar to that of FIG. 13 but showing an example of a leading edge angle (LEA) being greater than the average leading edge angle (ALEA) and achieved by varying the camber of the blade.

FIG. 19 is a cross-section view of a vane of the rearward array, showing a mean camber line and a leading edge angle for an open fan engine with the blades of the forward array arranged for counter-clockwise rotation.

FIG. 20 is a cross-section view of a vane of the rearward array, similar to that of FIG. 19 but showing the leading edge angle (LEA) being the same as an average leading edge angle (ALEA).

FIG. is a cross-section view of a vane of the rearward array, similar to that of FIG. 19 but showing an example of a leading edge angle (LEA) being less than the average leading edge angle (ALEA) and achieved by varying the stagger of the blade.

FIG. 22 is a cross-section view of a vane of the rearward array, similar to that of FIG. 19 but showing an example of a leading edge angle (LEA) being less than the average leading edge angle (ALEA) and achieved by varying the camber of the blade.

FIG. 23 is a cross-section view of a vane of the rearward array, similar to that of FIG. 19 but showing an example of a leading edge angle (LEA) being greater than the average leading edge angle (ALEA) and achieved by varying the stagger of the blade.

FIG. 24 is a cross-section view of a vane of the rearward array, similar to that of FIG. 19 but showing an example of a leading edge angle (LEA) being greater than the average leading edge angle (ALEA) and achieved by varying the camber of the blade.

FIG. 25A is a graph showing a first band of suitable ranges of the leading edge angle of a vane for a given Q.

FIG. 26A is a graph showing a second band of suitable ranges of the leading edge angle of a vane for a given, the second band being different than the first band of FIG. 25A.

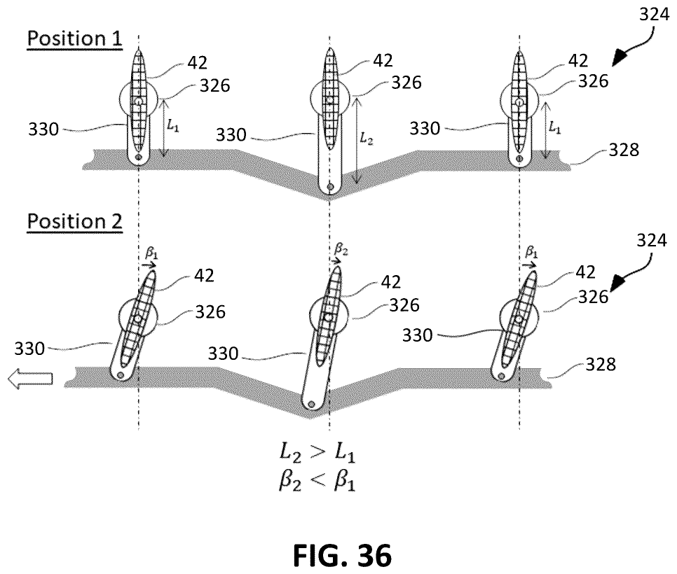

FIG. 25B is a graph showing a third band of suitable ranges of the leading edge angle of a vane for a given Φ corresponding to the first band of FIG. 25A modified by a dependence on RL/D for a first value of RL/D.

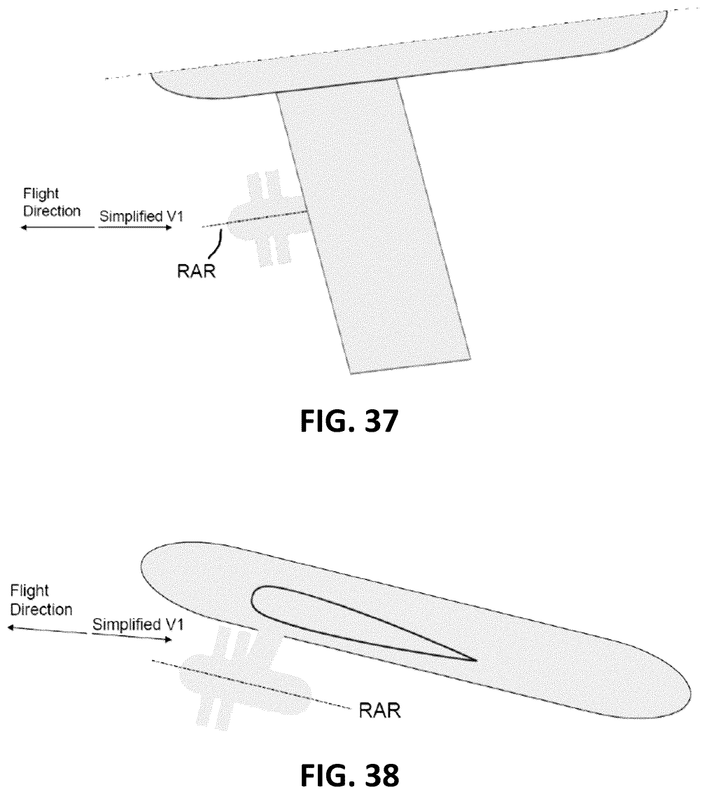

FIG. 26B is a graph showing a fourth band of suitable ranges of the leading edge angle of a vane for a given Φ corresponding to the second band of FIG. 26A modified by a dependence on RL/D for a first value of RL/D.

FIG. 25C is a graph showing a fifth band of suitable ranges of the leading edge angle of a vane for a given Φ corresponding to the first band of FIG. 25A modified by a dependence on RL/D for a second value of RL/D.

FIG. 26C is a graph showing a sixth band of suitable ranges of the leading edge angle of a vane for a given Φ corresponding to the second band of FIG. 26A modified by a dependence on RL/D for a second value of RL/D.

FIG. 27 is a schematic side elevation view of an exemplary vane suitable for use with the vane assembly described herein.

FIG. 28 is a schematic perspective view of an open fan engine with a rotor disk area added for reference and showing multiple exemplary local flow vectors over the rotor disk area.

FIG. 29 is a schematic perspective view of an open fan engine with a rotor disk area added for reference and showing a vector V1 with an upward flow component and showing the directions of a vector V2 for clockwise rotation and counter-clockwise rotation.

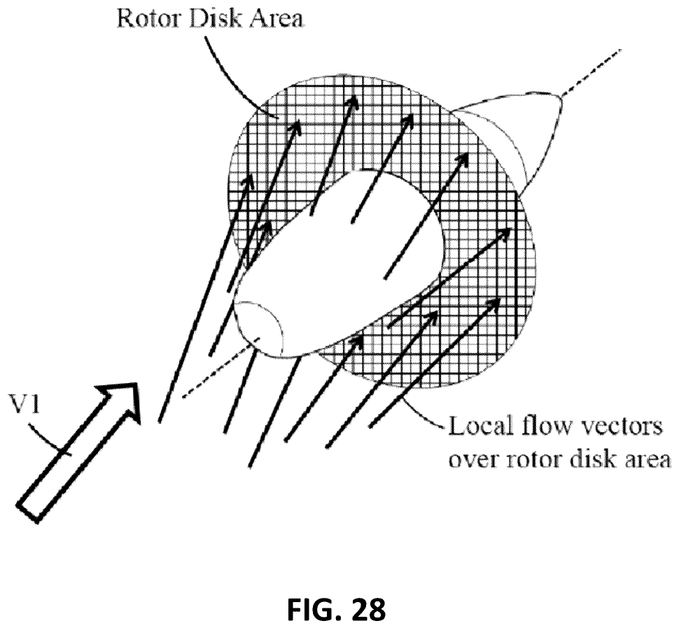

FIG. 30 is a forward-looking-aft view of the open fan engine of FIG. 19 showing the circumferential positioning vector (CPV) for clockwise and counter-clockwise rotor rotation based on V1.

FIG. 31 is a schematic perspective view of the open fan engine with the rotor disk area added for reference and showing a vector V1 with a left-to-right forward-looking-aft flow component and showing the directions of a vector V2 for clockwise rotation and counter-clockwise rotation.

FIG. 32 is a forward-looking-aft view of the open fan engine of FIG. 30 showing the circumferential positioning vector (CPV) for clockwise and counter-clockwise rotor rotation based on V1.

FIG. 33 is a schematic perspective view of the open fan engine with the rotor disk area added for reference and showing a vector V1 with an upward component and a right-to-left forward-looking-aft flow component and showing the directions of a vector V2 for clockwise rotation and counter-clockwise rotation.

FIG. 34 is a forward-looking-aft view of the open fan engine of FIG. 33.

FIG. 35 is a graph showing a delta in ALEA (DALEA=ALEA2−ALEA1) as compared to flow angularity (FA) for an exemplary arrangement.

FIG. 36 is a schematic roll-out view of an exemplary vane actuator system with trunnion arms of differing lengths.

FIG. 37 is a schematic, partial top plan view of an aircraft having a wing with an exemplary open fan engine mounted relative thereto, and showing a top view of a vector V1 that is simplified to be a vector of unit magnitude aligned to the flight direction and extending from upstream to downstream.

FIG. 38 is a schematic side elevation view of the aircraft of FIG. 37, showing a side view of the simplified vector V1 of FIG. 37.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Aspects and advantages of the present disclosure will be set forth in part in the following description or may be learned through practice of the present disclosure.

The word “or” when used herein shall be interpreted as having a disjunctive construction rather than a conjunctive construction unless otherwise specifically indicated.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

“Airfoil section” and “effective quarter chord point (QC)” are defined as follows.

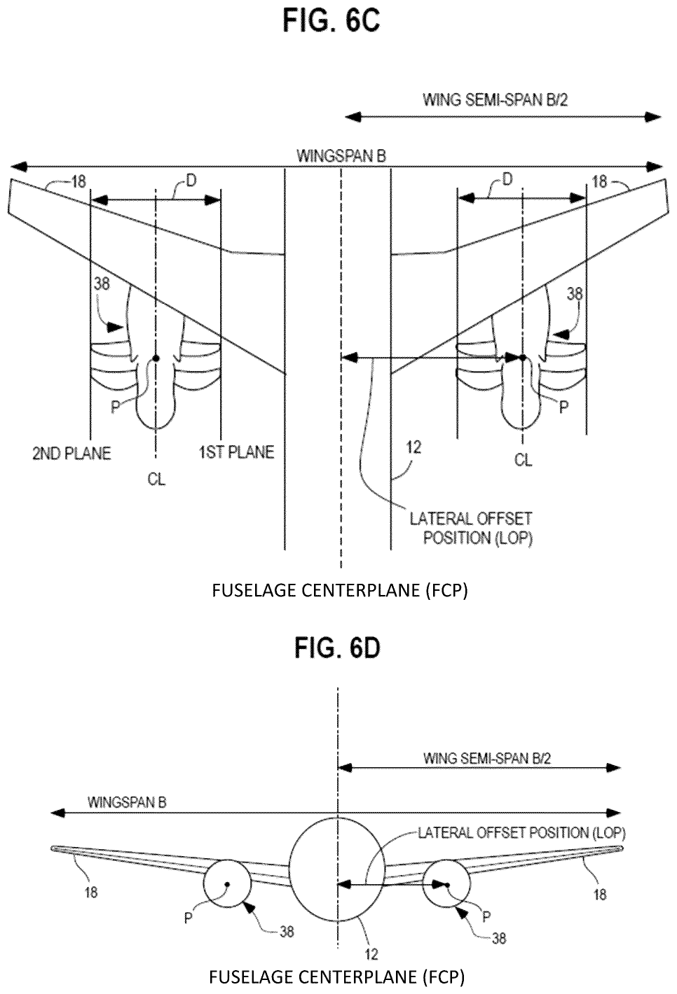

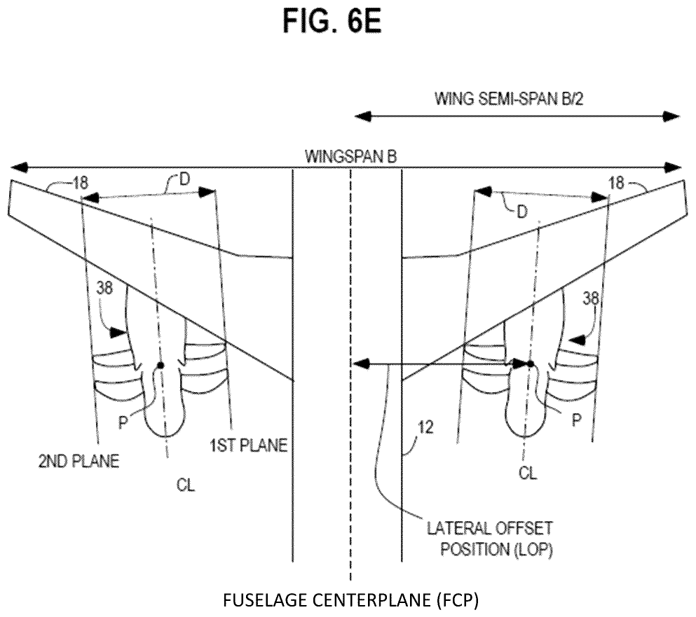

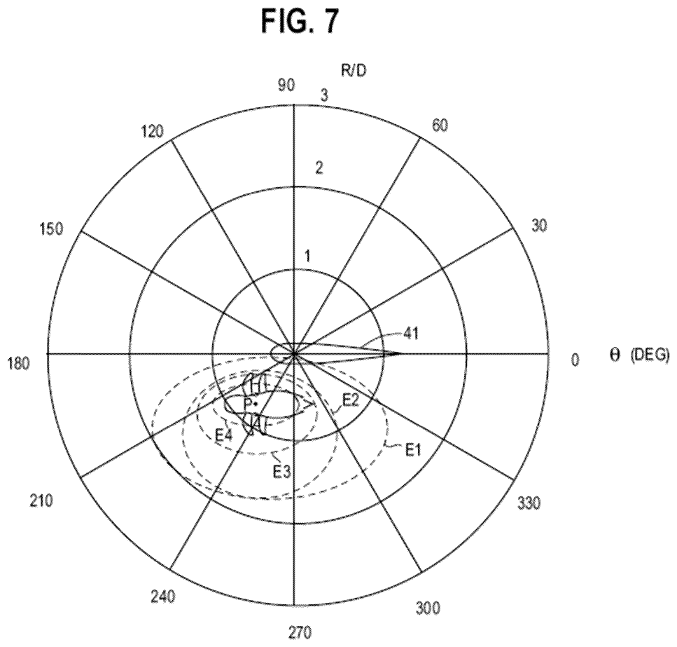

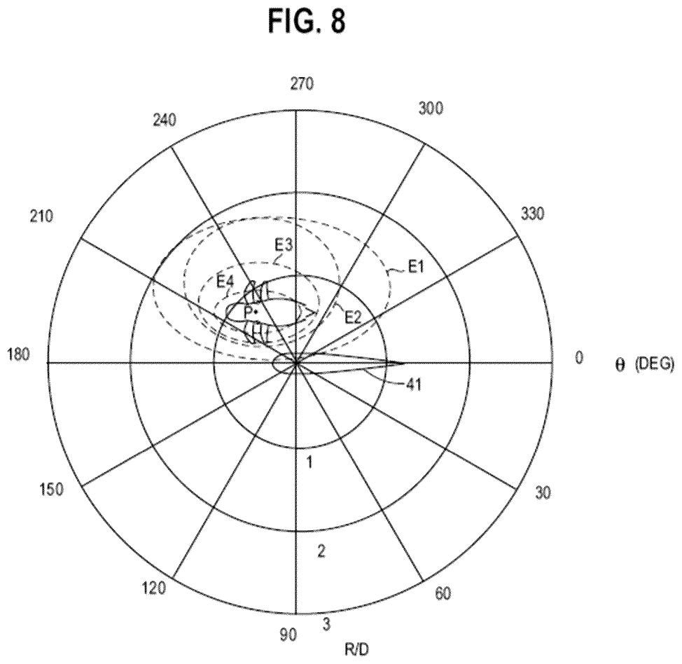

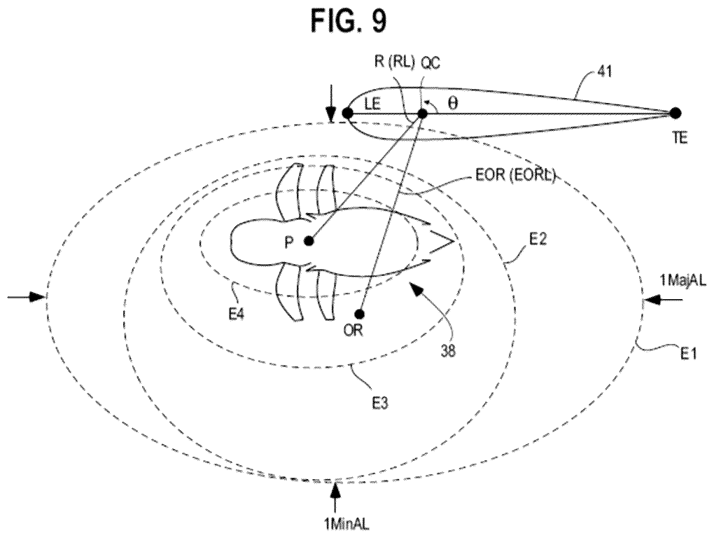

“Airfoil section” is defined as the average of a first offset plane section and a second offset plane section of an airfoil (e.g., an airfoil associated with a horizontal stabilizer or wing of an aircraft), where the first offset plane section is the section of the airfoil taken at a first plane and the second offset plane section is the section of the airfoil taken at a second plane, the first and second planes each being offset in a direction perpendicular to, and equidistant from a central plane by a distance of ½ of a fan diameter (D) of rotating blades of a propulsor mounted to the portion of the aircraft body associated with the airfoil section (wing or horizontal stabilizer). The first plane is inboard of the central plane (towards the fuselage) and the second plane is outboard of the central plane. When the aircraft is on the ground, both the gravity vector and axis of rotation of the rotating blades lie in the central plane. The intersection of the first offset plane with the airfoil defines a first section having a first section leading edge (LE1) and a first section trailing edge (TE1), with the LE1 at the forward-most point of the first section and the TE1 at the aft-most point of the first section. The intersection of the second offset plane with the airfoil defines a second section having a second section leading edge (LE2) and a second section trailing edge (TE2), with the LE2 at the forward-most point of the section and the TE2 at the aft-most point of the second section. Averaging the coordinates of LE1 and LE2 yields a representative LE location for the airfoil section. Averaging the coordinates of TE1 and TE2 yields a representative TE location for the airfoil section. The LE and TE points obtained this way are indicated in FIGS. 6 and 6B. An “Airfoil Section” defined herein has its leading and trailing edges TE, LE determined in this manner. “Effective Quarter-chord point” (“QC”) is defined as ¼ of the distance from the leading edge LE of the airfoil section determined in the foregoing manner, measured along the chord of this airfoil section. QC is dependent on the fan diameter (D) because the airfoil section LE and TE values change if D for the unducted fan propulsor changes.

“Cruise Speed” refers to aircraft speed and applies to a vehicle with a cruising altitude up to approximately 65,000 ft. In certain embodiments, cruise altitude is between approximately 28,000 ft. and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

It is understood that the plurality blades, whether forward or rearward, may have a variation of root forward-most points and root rearward-most points. This can be due to both installed position as well as orientation in the case of variable pitch blades. For purposes of defining the distances TRL, RTL, and VTL it is understood that a rotating blade or rotating array of blades are orientated such that the respective leading edges of the blades are in their most forward position, e.g., a feathered position. The respective trailing edge position is also obtained when the leading edge is in the most forward position. For purposes of defining the distances TRL, RTL, and VTL it is understood that the forward or leading edge or rearward or trailing edge of a stationary blade (or vane) or array of stationary blades (or vanes) is the most forward or leading edge position across the array of vanes or the most rearward or trailing edge position across the array of vanes.

“Blade” can refer to a stationary or rotating blade. “Stationary blade(s)” has the same meaning as “vane(s)”.

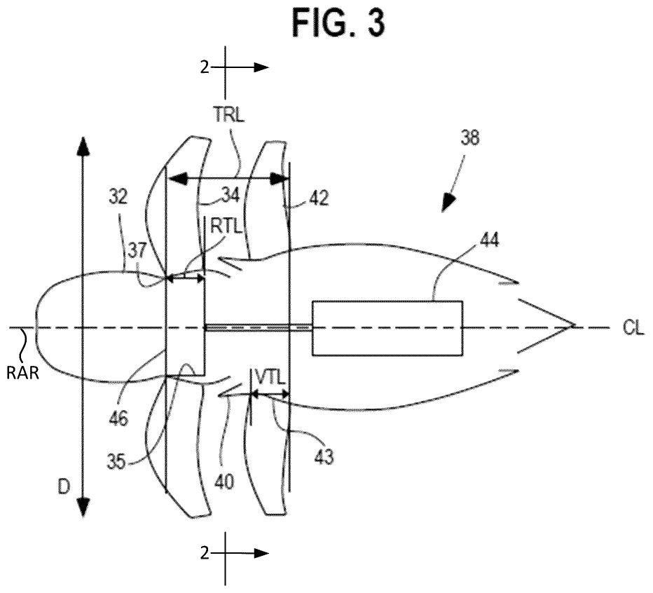

“Unducted fan propulsor” as used herein means an aircraft engine characterized by an array of rotating fan blades and static (or non-rotating), outlet guide vanes (OGV) aft of the array of rotating fan blades, or an array of rotating fan blades and static, unducted inlet guide vanes (IGV) forward of the rotating fan blades. In either case, neither the fan blades nor the IGV or OGV is surrounded by a duct or fan nacelle. FIG. 3 depicts an unducted fan propulsor. Additionally, the term unducted fan propulsor means an unducted, fan driven aircraft engine capable of providing thrust to an aircraft to enable cruise flight speeds between 0.7 Mach and 0.90 Mach, or 0.75 to 0.85 Mach.

“Aircraft” means a vehicle having a wing (and/or horizontal stabilizer), an airfoil defined by the wing (and/or horizontal stabilizer), and one or two unducted fan propulsors mounted to the wing, and the aircraft is operable at cruise flight speeds between 0.7 Mach and 0.90 Mach, or 0.75 to 0.85 Mach.

“Fuselage centerplane” (“FCP”) is defined as a plane that is located equidistant from the wingtips, intersecting the fuselage, and containing the gravity vector when the aircraft is on the ground.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “proximate” refers to being closer to one side or end than an opposite side or end.

The terms “clockwise” and “counter-clockwise” refer to the relative direction of rotation that is viewed from forward looking aft.

For a rotating propeller blade, a surface of the blade on an advancing side thereof, due to rotation, can be referred to as the pressure surface. A surface on the retreating side of the blade, due to rotation, can be referred to as a suction surface. The leading edge of a propeller blade is used herein to refer to a three-dimensional curve at which the suction surface and pressure surface meet on an upstream edge of the blade, based on the flight direction. A trailing edge refers to an intersection of the same suction surface and pressure surface on the downstream edge of the blade. The mean surface is used herein to refer to the imaginary surface connecting the leading edge to trailing edge, which lies between the pressure surface and suction surface. The leading and trailing edges for a stationary vane are defined in the same way as for the rotating blade, with the vane suction and pressures sides being reversed from those of the blade.

The term “sideslip” refers to the flow direction angle relative to a plane that passes through the axis of rotation of the rotor and the vertical direction. An aircraft may operate in a condition where the aircraft is rotated in the yaw direction relative to the direction of flight. This will create a sideslip angle relative to the engine which will be seen as a horizontal component of flow entering the rotor inlet.

The term “disk area” refers to an imaginary annular planar surface that is normal to and centered about the axis of rotation of the rotor. In the axial direction the planar surface is aligned to the most forward location of a rotor or vane. The annulus outer and inner radii correspond to the maximum and minimum radii of the rotor or vane relative to the axis of rotation of the rotor.

The term “V1” refers to a vector of unit magnitude and represents the average flow direction integrated over the disk area of the intended rotor location as it would be positioned on an aircraft but without the effects of the engine on the flow for a given flight condition. In one aspect, the term “V1” can be simplified to be a vector of unit magnitude aligned to the flight direction extending from upstream to downstream.

The term “V2” refers to a vector of unit magnitude and represents the rotor axis of rotation RAR of the open fan engine, where the direction depends on the rotation direction of the rotor. For clockwise forward looking aft (FLA) rotor rotation, V2 extends from forward to aft along the rotor axis of rotation RAR and for counter-clockwise FLA rotor rotation V2 extends from aft to forward along the rotor axis of rotation RAR.

The term “flow separation,” also known as boundary layer separation, as used herein, refers to the detachment of a boundary layer of the flow from a surface of an airfoil, e.g., a vane.

The inventors were faced with a problem of how to improve thrust delivered to an aircraft by an unducted fan propulsor without increasing the required engine power delivered to the unducted fan of the unducted fan propulsor.

It was surprisingly found that the solution to this problem is heavily dependent on the location of the unducted fan propulsor relative to the aircraft wing.

The inventors found that installing an unducted fan propulsor presents the challenge of addressing penalties that can result due to the interaction with the rest of the aircraft. The manner in which these penalties are addressed according to the claimed subject matter is unique for this type of engine.

An unducted fan propulsor is particularly challenged due to the scrubbing and interference drags relative to a ducted turbofan. That additional drag then results in a higher thrust needed from the propulsor. Generally, higher thrust for a ducted turbofan comes with a larger power requirement and thus more fuel flow. For the unducted fan propulsor it was surprisingly found by placing the engine so that it can take advantage of the high pressure flow induced by the wing (and/or a horizontal stabilizer), engine thrust may increase without increasing the power requirement on the engine. This placement of the engine relative to the wing then acts to offset the scrubbing and interference drag, thus not increasing the required fuel (or reducing the increased fuel flow required for a non-optimum engine placement). The inventors found that increased drag effects associated with an unducted fan propulsor, rather than addressed directly, may instead be offset by placing the engine at a more optimal location relative to the wing.

Additionally, the inventors found that the installed engine's improved position also positively influences the noise produced by the wing-engine interaction during flight at cruise conditions.

It was surprisingly found that by adapting a particular location on an unducted fan propulsor relative to an aircraft wing's effective quarter chord point (QC), the desired result of offsetting interference and scrubbing drag without increasing the power delivered to the fan could be achieved for an unducted fan propulsor.

It was also found that the improved position is dependent on the fan blade size of the unducted fan propulsor.

As explained below, after recognizing the novel flow characteristics associated with an unducted fan propulsor installed on an aircraft, taking into account the limitations on where to place this propulsor, the inventors were surprisingly able to establish criteria for positioning the propulsor relative to an aircraft wing to offset interference and scrubbing effects by defining a midpoint (P) location between external output guide vanes (OGV) or input guide vanes (IGV) and a forward or aft rotating array of fan blades, respectively, and additionally defining the distance from the effective quarter chord point (QC) to P. The position of P relative to QC and QC itself were found dependent on the rotating fan diameter. The correlation of these parameters to offset interference and scrubbing effects was not used before and was the surprising finding of the inventors for an unducted fan propulsor. Thus, mounting unducted fan propulsors relative to the effective quarter-chord point (QC) and fan blade size as described in embodiments provided herein offsets interference and scrubbing effects associated with an unducted fan propulsor and is an improvement over other mounting locations, including conventional mounting locations that are more forward of, and more in line with, a wing chord line.

Various aspects of the present disclosure describe aspects of an aircraft characterized in part by a specific relation between an effective quarter chord point (QC) of an airfoil section associated with a wing (or horizontal stabilizer) and the unducted fan propulsor, which is believed to result in improved aircraft performance and/or fuel efficiency. According to the disclosure, an aircraft includes a fuselage and an unducted fan propulsor installed relative to a section of the wing or the horizontal stabilizer.

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

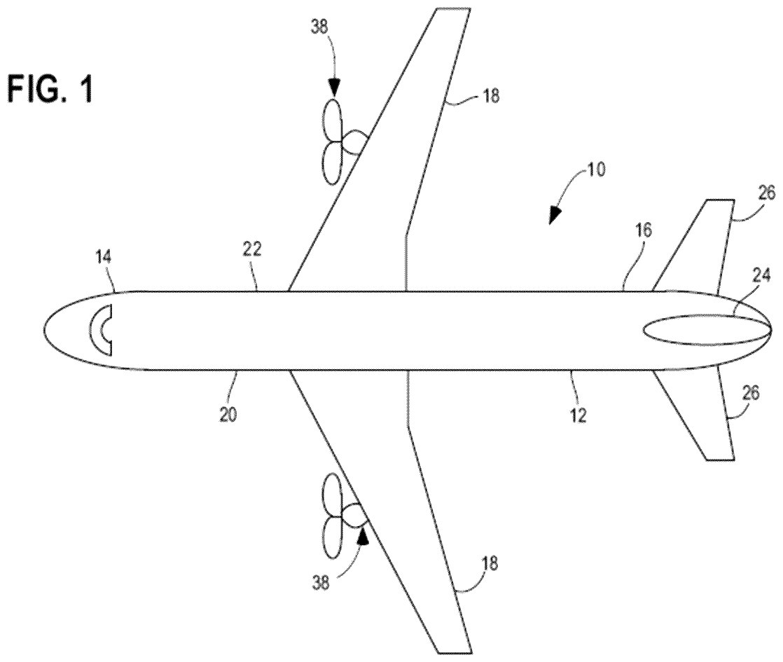

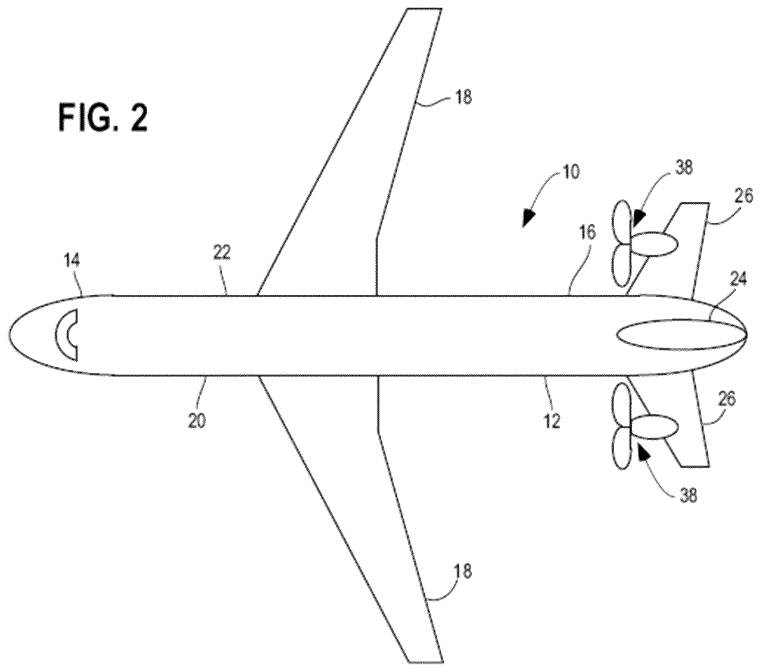

As shown in FIGS. 1 and 2, the aircraft 10 includes a fuselage 12 that extends longitudinally from a forward or nose section 14 and an aft or tail section 16 of the aircraft 10. The aircraft 10 further includes airfoils including a first wing 18 that extends laterally outwardly from a port side 20 and a second wing 18 that extends laterally outwardly from a starboard side 22 of the fuselage 12. The tail section 16 of the aircraft 10 includes a vertical stabilizer 24, a first airfoil of the horizontal stabilizer 26 that extends laterally outwardly from the port side 20, and a second airfoil of the horizontal stabilizer 26 that extends laterally outward from the starboard side 22 of the fuselage 12. An unducted fan propulsor 38 is undermounted relative to each of the wings 18, as shown in the embodiment of FIG. 1. Alternatively, the unducted fan propulsor 38 is mounted relative to the top of each of the horizontal stabilizers 26, as shown in FIG. 2. In some embodiments, more than one of the unducted fan propulsors 30 or 38 may be mounted to each of the wings 18 or each of the horizontal stabilizers 26.

FIG. 3 shows an elevational cross-sectional view of an embodiment of one of the unducted fan propulsors 38. As is seen from FIG. 3, the unducted fan propulsor 38 takes the form of an open fan propulsion system and has a rotating element in the form of rotatable propeller assembly 32 on which is mounted a first array of blades 34 around a centerline (CL) of the unducted fan propulsor 38. The first array of blades 34 defines a diameter D representing the tip-to-tip diameter of the blades and a maximum radial extent from CL. This diameter D is measured along a radial direction perpendicular to CL. The unducted fan propulsor 38 of FIG. 3 includes a second array of blades or vanes, which are non-rotating or static. In some embodiments, a non-rotating stationary element in the form of vane assembly 40 includes an array of vanes 42 disposed around CL.

Each of the blades 34 has a root 35 where the blade 34 is attached to the rotatable propeller assembly 32, and each blade 34 defines a root length (RTL). The root length (RTL) is defined as the axial extent (in a direction parallel to CL) from the radially innermost leading edge (LE) of the blade 34 airfoil, e.g., closest to CL, to the axial location of the radially innermost trailing edge (TE) of the blade 34 airfoil.

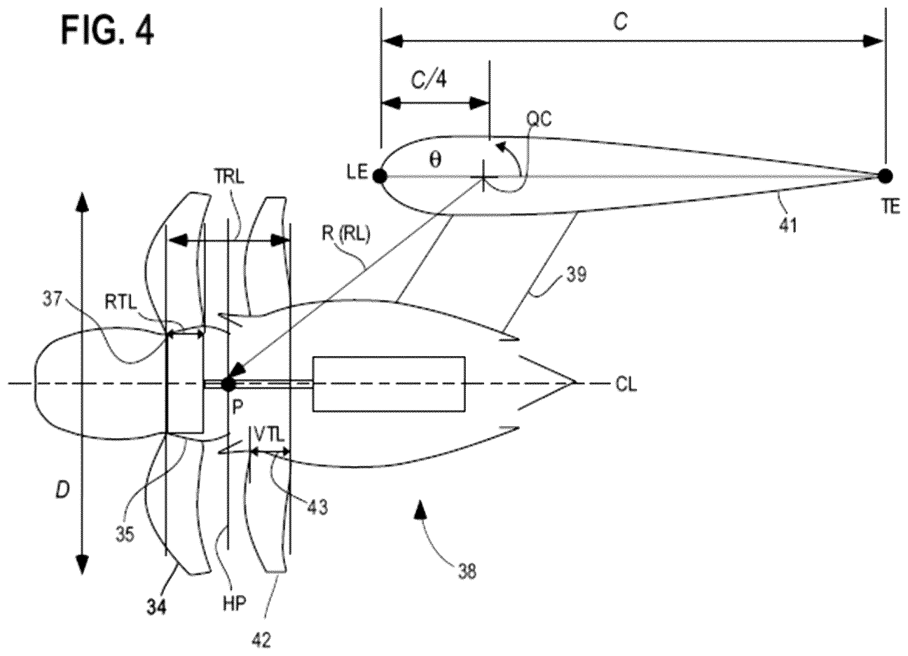

Each of the vanes 42 also has a root 43 with a vane root distance VTL where the vane 42 is attached to the non-rotating vane assembly 40. The total root length (TRL) is the distance between the leading edge (LE) of the blade 34 airfoil (radially nearest to CL) of the blades 34 and the trailing edge (LE) of the root 43 of the vanes 42, as shown in FIGS. 3 and 4. TRL is a measured axial distance from the radial innermost LE of the foremost row of blades/vanes and the trailing edge (TE) of the vanes 42. In some embodiments, the second array may instead be a second rotating elements and the TRL is the measured axial distance from the radially innermost LE of the blades 34 of the first rotating element and the TE of the root of the blades of the second rotating elements. In some embodiments, the vanes 42 may be forward of the rotating blades, and the TRL is the distance between the LE edge of the root of the vanes and the TE of the root of the rotating blades. In some embodiments, an unducted fan propulsor having rotating elements (e.g., rotating blades) and stationary elements (e.g. vanes) may be mounted according to the relationship described in the present disclosure. In unducted fan propulsors having multiple rows of blade and/or vanes, the TRL of an unducted fan propulsor is defined as the distance between the LE of the root of the foremost row of blades/vanes and the rearward edge of the root of the aftmost row of blades/vanes of the unducted fan propulsor.

Referring to FIG. 4, for purposes explained more later, the unducted fan propulsor 38 has a point P. For the unducted fan propulsor 38 with a first array of blades or vanes 34 and a second array of blades or vanes 42, as shown in FIGS. 3 and 4, the point P is located at the intersection of CL and a line HP perpendicular to CL and that passes through an axial midpoint of the total root length TRL between a forward end at the root of one of the blades 34 of the forward array and a rearward end at the root of one of the blades 42 of the rearward array when aligned with the one of the blades 34 of the forward array, as shown in FIG. 6. Either the forward or rearward array can be vanes or blades. In other words, the line HP is located equidistant from a forward end of the root of one of the forward vanes or blades 34 and a rearward end of the root of one of the rearward blades or vanes 42. The TRL of an unducted fan propulsor is defined as the distance between the LE of the root of the forward row of blades/vanes and the rearward edge of the root of the aftmost blade/vane.

Referring again to FIG. 3, the exemplary unducted fan propulsor 38 includes a drive mechanism 44 that provides torque and power to the propeller assembly 32 through a transmission 46. The drive mechanism 44 may be a gas turbine engine and associated transmission 46. Transmission 46 delivers torque from the drive mechanism 44 to the propeller assembly 32. The transmission system can be configured as a direct drive engine, transferring power from a power turbine or low pressure turbine (LPT) to the propeller assembly, or an indirect drive system where torque from the LPT is transferred to the propeller assembly 32 through a gearbox. The gearbox reduces a rotation speed of the drive shaft to match a desired rotational speed for the propeller assembly 32. The gas turbine engine includes in serial order a compressor, combustor, high pressure turbine and the LPT. In other embodiments the drive mechanism may generate power partially or fully by an electric motor. In the former case the drive mechanism is a hybrid electric drive mechanism including a gas turbine engine where a drive shaft includes an electric motor-generator for generating torque. In the latter case the drive mechanism is an electric motor.

The unducted fan propulsor 38 is attached relative to the wings 18 or horizontal stabilizer 26 through one or more intermediate components or features, e.g., a pylon 39, as shown in FIG. 4.

Each of the wings 18 shown in FIG. 1, and horizontal stabilizers 26 shown in FIG. 2, has an airfoil section 41 associated with it, where the airfoil section 41 is defined above.

As depicted in FIG. 4, a chord line C of the airfoil section, length C as shown, is a straight line extending from LE to TE of the airfoil section (it will be understood that the airfoil section as shown and defined herein is not meant to indicate any particular camber associated with an aircraft wing). The effective quarter-chord point (QC) of the airfoil section is located on the chord line. QC is located at a distance of C/4 from the LE of the airfoil section 41.

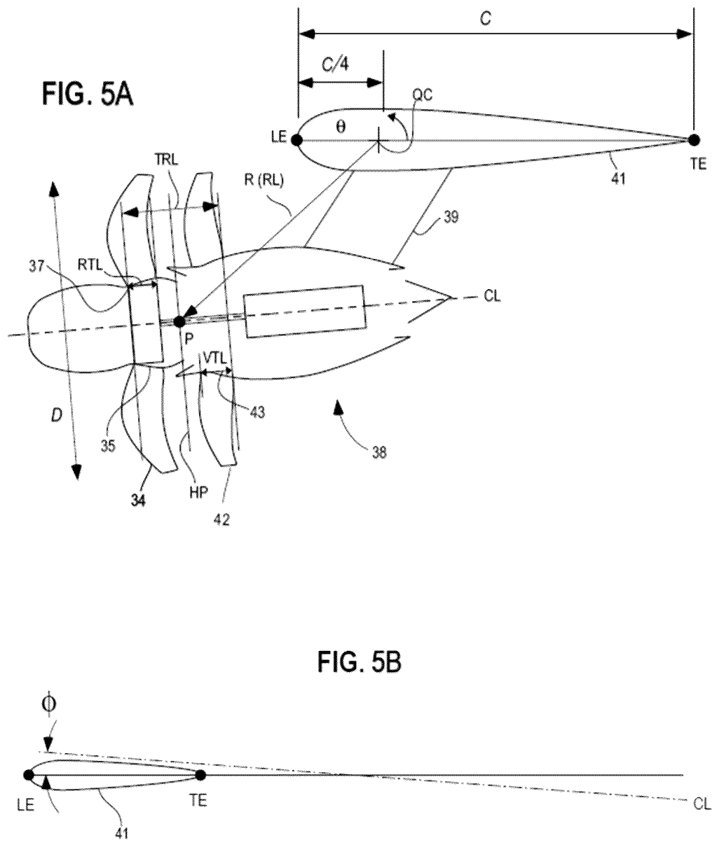

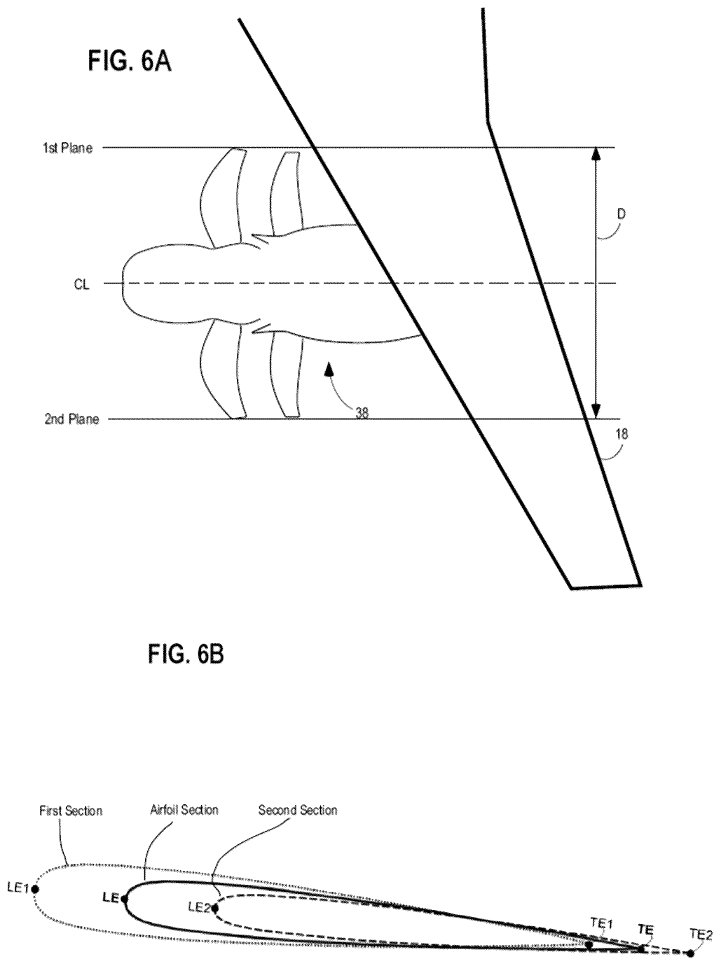

As shown in FIG. 4, the CL of the propulsor 38 and the chord line C are parallel to each other, corresponding to a zero pitch of the propulsor relative to the chord line C. The propulsor 38 can be pitched at different angles relative to the chord line, such as pitched downward as shown in FIG. 5A. FIG. 5B defines a pitch angle Φ for the propulsor 38, which is the angle spanned between the propulsor centerline CL and chord line C. Positive pitch corresponds to a clockwise rotation of CL relative to C. The pitch angle Φ can be fixed or variable during flight. For underwing installations, the pitch angle Φ can vary between −5 and +2 degrees, or it can vary between −3 and 0 degrees. During cruise conditions, propulsor pitch and toe angle (FIG. 6E, defined below) provide for an improved installed aerodynamic performance for the unducted fan propulsor in terms of reduced cabin noise and reduced off-axis loading of the unducted fan propulsor's drive shaft. For aft horizontal stabilizer or aft fuselage installations, the angle Φ can vary between −2 and +5 degrees to more align with downwash created by the wing.

The position of the open fan propulsor 38 is defined relative to QC. The airfoil section, as defined above, is the average of a first offset plane section and a second offset plane section of the airfoil (of the wing), where the first offset plane section is the section of the airfoil taken at a first plane and the second offset plane section is the section of the airfoil taken at a second plane, the first and second planes being offset in a direction perpendicular to, and equidistant from a central plane by a distance of ½ the maximum fan diameter (D) for the rotating blades, as shown in FIG. 6A. Both the gravity vector and axis of rotation of the rotating blades of the propulsor lie in this central plane when the aircraft is on the ground.

Referring to FIG. 6C, the propulsor 38—specifically, point P of the propulsor 38—has a spanwise location laterally offset from the fuselage centerplane (FCP) relative to the aircraft's wingspan B. P has a laterally offset position (LOP) between 10% and 80%, 20% and 40%, or between 25% and 35% of B/2 measured from the fuselage centerplane (FCP), as defined above. The location of P is also chosen to avoid interference with the fuselage or an adjacent propulsor if more than one propulsor is mounted relative to the wing. For an aft fuselage installation, the LOP of the propulsor will be closer to the fuselage, but far enough away from the fuselage's boundary layer to reduce or avoid undue interaction with the fuselage boundary layer.

As shown in FIG. 6C, the propulsor centerline CL and the fuselage centerplane (FCP) can be orientated parallel to each other. Referring to FIG. 6D, other angles between propulsor centerline CL and the fuselage centerplane (FCP) are contemplated. For an underwing mounted propulsor, the toe angle can provide added benefit when positive (i.e., the rotor toed-in towards the fuselage with the forward end of the propulsor 38 being more inboard than the aft end). The propulsor can have an inward toe angle of between 0 and 5 degrees, or between 1 and 3 degrees.

There are specific locations that the inventors have found to be advantageous to position the unducted fan propulsor 38 to generate increased thrust using higher pressure air flow, in order to offset the scrubbing and interference drag. The higher pressure air flow can be beneath the wings 18. In the case of a horizontal stabilizer 26, the higher pressure air flow is above the horizontal stabilizer 26. Accordingly, the high-pressure side of an airfoil may refer to the underside of a wing 18 or the top side of a horizontal stabilizer 26.

The aircraft described herein has a fuselage, wings and/or stabilizers, and two or more unducted fan propulsor systems (or propulsors). The unducted fan propulsor system, which is mounted on the pressure side of a wing or horizontal stabilizer, provides thrust to the aircraft. To improve upon what the propulsor system can deliver, there often is a need to make compromises to other parts of aircraft design (trade-offs). Stated another way, the benefits of an unducted fan propulsor cannot be viewed without consideration of the effect of placement of the propulsor on the aircraft. For example, placement can affect loads on and size of the pylon, wing loads, landing gear length and associated forces, weight, and cost.

The teachings described below enable improved balancing of the tradeoffs required in the aircraft design while positioning the unducted fan propulsor relative to the airfoil section's effective quarter chord point QC to offset scrubbing and interference drag loses.

Referring to FIG. 4, the location of an unducted fan propulsor relative to an airfoil section 41 is defined herein using a polar coordinate system having an angular (θ) coordinate and a radial (R) component, with origin located at the effective quarter chord point (QC) of the airfoil section having a chord length (C) as shown. The radial component is referred to herein as a “positioning line (R)”. The location of the point P of the unducted fan propulsor 38 relative to the origin (QC) of the polar coordinate system (the origin of the coordinate system is the same as the effective quarter chord point for airfoil section 41) is expressed in terms of a vector having radial component R with magnitude RL and angular component θ. The vector magnitude RL is called a “positioning line length (RL)”.

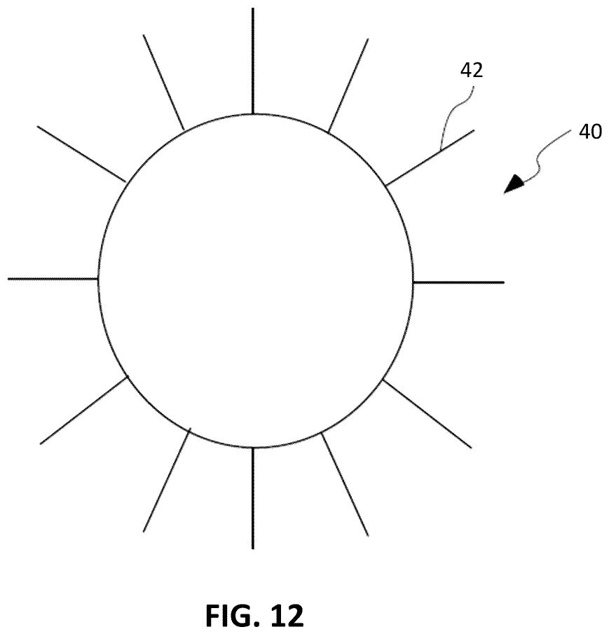

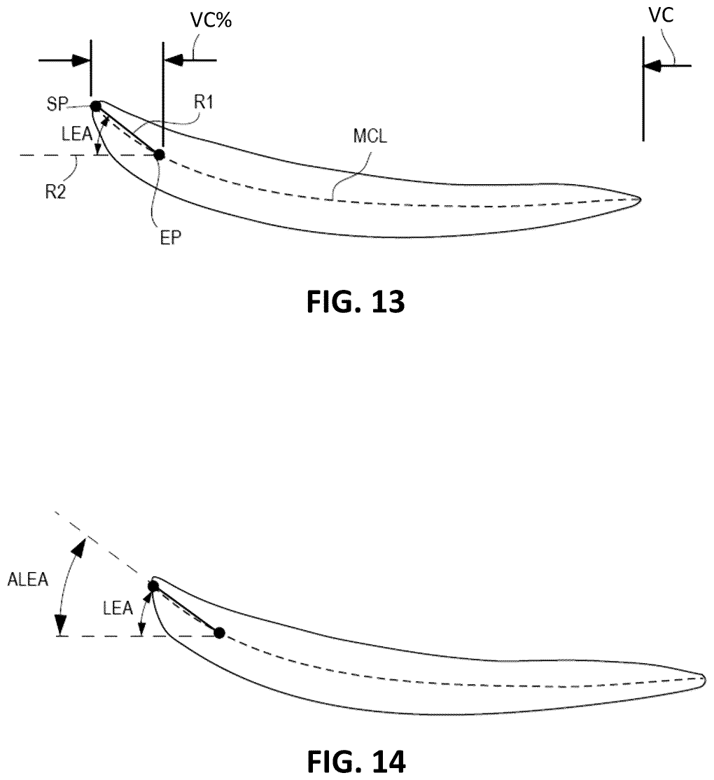

The angle θ is measured relative to a datum that is the airfoil section chord line (e.g., in FIG. 6 the vector R is located by an angle that is between 180 and 270 degrees measured counterclockwise about origin QC relative to the chord line). When viewed looking from an outboard position towards an inboard position (e.g., the fuselage), θ is positive in a counter-clockwise direction when the propulsor is below the airfoil section 41 (wing, FIG. 9), and θ is positive in a clockwise direction when the propulsor is above the airfoil section (horizontal stabilizer, FIG. 10) as indicated in the drawings, respectively, by the direction of the arrow from the origin.

The inventors found that for an unducted fan propulsor system the ratio of RL over D (i.e., RL/D) is desirably less than or equal to 2, less than or equal to 2 and greater than or equal to 0.15, or less than or equal to 2 and greater than or equal to 0.35. Additionally, for the undermounted unducted fan propulsor systems (pressure side of the airfoil section) of FIGS. 5 and 6 the angular component θ associated with these ranges for RL/D and locating the unducted fan propulsor system (i.e., the location of P relative to the airfoil section) are desirably between 187° and 342°, between 198° and 310°, or between 205° and 285°. These regions of RL and θ locating the unducted fan propulsor system relative to the airfoil section tend to offset scrubbing and interference drag for an unducted fan propulsor.

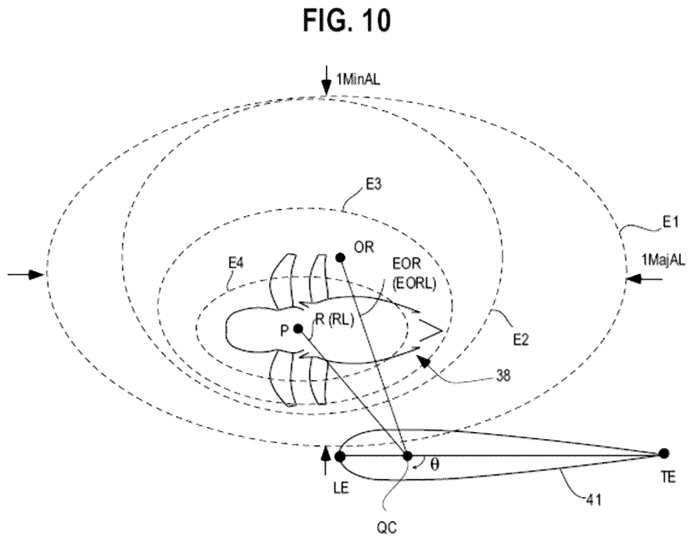

Alternatively, the point P for the unducted fan propulsor can be located within a defined ellipse defining a region relative to QC where scrubbing and interference drag tends to offset. FIGS. 7-10 each illustrate such ellipses according to several embodiments. Each of the ellipses has an origin OR, a major axis length (MajAL), and a minor axis length (MinAL), as shown in FIGS. 9 and 10 with respect to one of several ellipses and as will be explained further below. The location of OR is expressed relative to QC using the polar coordinate system frame of reference defined earlier. The propulsor system is mounted such that the point P of the unducted fan propulsors 38 is located within an ellipse as defined herein.

Referring to FIG. 9, the radial ellipse origin positioning line (EOR) extends from the ellipse origin OR, e.g., ellipse E1, to QC. The ellipse origin position line EOR has a length EORL. The origin of each of the ellipses is defined in the adopted polar coordinates with a radial coordinate defined as the ratio of EORL to the array of blades diameter (D), i.e., the quantity EORL/D. The angle θ is measured relative to the chord line (as defined earlier) and positive in a clockwise direction when the propulsor is above the airfoil section (horizontal stabilizer, FIG. 10) as indicated in the drawings, respectively, by the direction of the arrow from the origin.

An angle θ for the ellipse origin positioning line EOR is measured from a datum that is the chord line to an ellipse positioning line EOR (e.g., in FIG. 9 the vector EOR is located by an angle that is between 180 and 270 degrees measured counterclockwise about origin QC). A positive θ (1) increases in a counter-clockwise direction when the high pressure side of the airfoil section is below the airfoil section, and (2) increases in a clockwise direction when the high pressure side of the airfoil section is above the airfoil section.

In a first embodiment, the point P of the unducted fan propulsor 38 is located in a first ellipse E1 with a first ellipse origin defined by EORL/D of 0.938 and θ of 253.6°. The first ellipse E1 also has a first major axis length (1MajAL) and a first minor axis length (1MinAL), where 1MajAL/Dis 2.8 and 1MinAL/Dis 1.7. A unducted fan propulsor located within E1 tends to offset scrubbing and interference drag.

In a second embodiment, the point P of the unducted fan propulsor 38 is located in a second ellipse E2 having a second ellipse origin defined by EORL/D of 1.051 and θ of 248.8°. The second ellipse E2 has a second major axis length (2MajAL) and a second minor axis length (2MinAL), where 2MajAL/D is 1.86 and 2MinAL/D is 1.56. A unducted fan propulsor located within E2 tends to offset scrubbing and interference drag.

In a third embodiment, the point P of the unducted fan propulsor 38 is located in a third ellipse E3 having a third ellipse origin defined by EORL/D of 0.870 and θ of 239.6°. The third ellipse E3 has a third major axis length (3MajAL) and a third minor axis length (3MinAL), where 3MajAL/Dis 1.4 and 3MinAL/D is 0.9. A unducted fan propulsor located within E3 tends to offset scrubbing and interference drag.

In a fourth embodiment, the point P of the unducted fan propulsor 38 is located in a fourth ellipse E4 having a fourth ellipse origin defined by EORL/D of 0.763 and θ of 235.7°. The fourth ellipse E4 has a fourth major axis length (4MajAL) and a fourth minor axis length (4MinAL), where 4MajAL/D is 0.94 and 4MinAL/D is 0.44. A unducted fan propulsor located within E4 tends to offset scrubbing and interference drag.

The location of the unducted fan propulsor system (i.e., point P) relative to the airfoil section may also be expressed in terms of the following expressions:

$$\frac{RL}{D} + \frac{\begin{matrix}( \sqrt{a * [ b * {sin}^{2} ( θ ) - c * {cos}^{2} ( θ ) + d * sin ( θ ) * cos ( θ ) ]} + \\ e * sin ( θ ) + f * cos ( θ ) )\end{matrix}}{g * {sin}^{2} ( θ ) + h * {cos}^{2} ( θ )} > 0$$

$$and$$

$$\frac{RL}{D} + \frac{\begin{matrix}( - \sqrt{a * [ b * {sin}^{2} ( θ ) - c * {cos}^{2} ( θ ) + d * sin ( θ ) * cos ( θ ) ]} + \\ e * sin ( θ ) + f * cos ( θ ) )\end{matrix}}{g * {sin}^{2} ( θ ) + h * {cos}^{2} ( θ )} < 0$$

where 0.07<RL/D<1.98 and θ is between 187° and 340°, and where a, b, c, d, e, f, g and h have the values set forth in the following table under the heading “Fifth Emb.”:

| | Fifth | Sixth | Seventh | Eighth |
|---|---|---|---|---|
| Variable | Emb. | Emb. | Emb. | Emb. |
| a | 1.4161 | 0.52621 | 0.09923 | 0.01069156 |
| b | 1.88978 | 0.7205 | 0.2964 | 0.036 |
| c | 0.0875 | 0.352 | 0.36 | 0.3485 |
| d | 0.477 | 0.7448 | 0.66 | 0.5418 |
| e | 1.764 | 0.8476 | 0.3675 | 0.139167 |
| f | 0.19146 | 0.23119 | 0.0891 | 0.020812 |
| g | 1.96 | 0.8649 | 0.49 | 0.2209 |
| h | 0.7225 | 0.6084 | 0.2025 | 0.0484 |

In a sixth embodiment, the point P of the unducted fan propulsor 38 can be defined by the above expression, but where 0.254<RL/D<1.86 and θ is between 199° and 306°, and where a, b, c, d, e, f, g and h have the values set forth in the above table under the heading “Sixth Emb.”

In a seventh embodiment, the point P of the unducted fan propulsor 38 can be defined by the above expression, but where 0.369<RL/D<1.43 and θ is between 204° and 291°, and where a, b, c, d, e, f, g and h have the values set forth in the above table under the heading “Seventh Emb.”.

In an eighth embodiment, the point P of the unducted fan propulsor 38 can be defined by the above expression, but where 0.477<RL/D<0.9455 and θ is between 211° and 274°, And where a, b, c, d, e, f, g and h have the values set forth in the above table under the heading “Eighth Emb.”

The unducted fan propulsor locations illustrated in FIG. 7 are made relative to an airfoil section of an aircraft wing and refer to an undermounted unducted fan propulsor system.

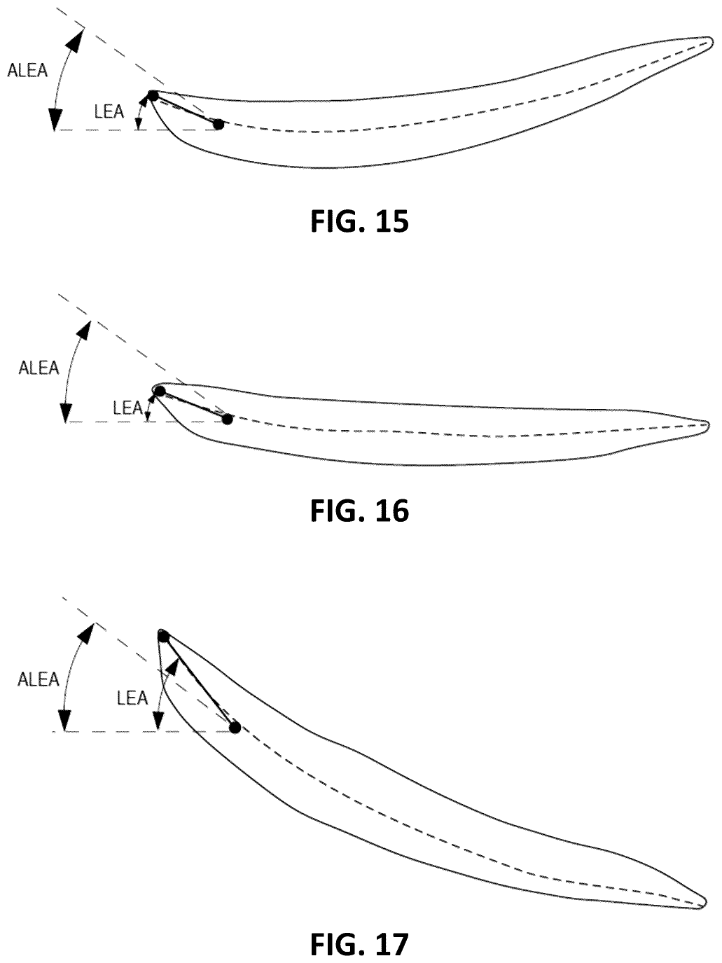

TABLES 1 and 3-6 set forth examples of embodiments of invention. TABLE 1 shows each maximum outer diameter (D) and the location of point P of the unducted fan propulsor relative to the effective quarter chord point, QC, contemplated, where the point P is defined by RL and θ. The term “Ref.” refers to the row in Table 1 for reference. The exemplary types of aircraft indicated with reference letters A through I in TABLE 1 are identified in TABLE 2. The point P of the unducted fan propulsor locations from TABLE 1 are shown in FIG. 11 for an under-wing mounted propulsor (for a propulsor mounted above a horizontal stabilizer the maximum outer diameter (D) and the point P of the unducted fan propulsor locations would be mirrored about the chord line of the airfoil section, which, for purposes of explanation, may be thought of as an axis passing through θ=0 deg and θ=180 deg in FIG. 11) relative to the first ellipse (E1), second ellipse (E2), third ellipse (E3), and the fourth ellipse (E4). The size of the points in FIG. 11 represent the relative size of D for the range provided in TABLE 1 (not to scale). The rotating blades diameter (D) may be between 2-50, 8-16, 10-15, 12-14, or 14-16 feet.

TABLE 1
P-location relative to airfoil section quarter chord point (QC)

| | Type of | RL | D | θ | |
|---|---|---|---|---|---|
| Ref. | aircraft | (ft) | (ft) | (deg) | RL/D |
| 1 | C I | 2.60 | 2.0 | 220.00 | 1.30 |
| 2 | F I | 1.07 | 2.0 | 189.00 | 0.54 |
| 3 | I | 3.13 | 2.0 | 199.73 | 1.57 |
| 4 | C F I | 2.18 | 3.0 | 319.20 | 0.73 |
| 5 | F I | 2.82 | 3.0 | 242.40 | 0.94 |
| 6 | C I | 1.47 | 4.0 | 293.60 | 0.37 |
| 7 | C I | 2.43 | 4.0 | 217.87 | 0.61 |
| 8 | I | 6.64 | 4.0 | 259.47 | 1.66 |
| 9 | C F I | 4.23 | 5.0 | 265.87 | 0.85 |
| 10 | C H I | 6.57 | 5.0 | 194.40 | 1.31 |
| 11 | F I | 2.03 | 5.0 | 250.93 | 0.41 |
| 12 | C F H I | 8.03 | 5.0 | 275.47 | 1.61 |
| 13 | C | 2.52 | 6.0 | 337.33 | 0.42 |
| 14 | H | 4.44 | 6.0 | 228.53 | 0.74 |
| 15 | C I | 1.88 | 6.0 | 208.27 | 0.31 |
| 16 | C F | 7.14 | 7.0 | 244.53 | 1.02 |
| 17 | B F H | 4.15 | 7.0 | 332.00 | 0.59 |
| 18 | B C I | 6.49 | 7.0 | 292.53 | 0.93 |
| 19 | C G | 8.05 | 8.0 | 216.80 | 1.01 |
| 20 | B F I | 11.89 | 8.0 | 256.27 | 1.49 |
| 21 | C G H | 10.08 | 8.0 | 277.60 | 1.26 |
| 22 | B C G I | 7.31 | 8.0 | 330.93 | 0.91 |
| 23 | C H | 9.97 | 8.0 | 294.67 | 1.25 |
| 24 | G I | 11.57 | 8.0 | 312.80 | 1.45 |
| 25 | B F I | 11.58 | 9.0 | 260.53 | 1.29 |
| 26 | C H | 6.06 | 9.0 | 224.27 | 0.67 |
| 27 | F G H | 3.06 | 9.0 | 233.87 | 0.34 |
| 28 | C I | 12.78 | 9.0 | 204.00 | 1.42 |
| 29 | B H | 10.47 | 10.0 | 210.40 | 1.05 |
| 30 | B I | 5.53 | 10.0 | 221.07 | 0.55 |
| 31 | A B C F G H | 7.00 | 10.0 | 253.07 | 0.70 |
| 32 | I | 2.47 | 10.0 | 306.40 | 0.25 |
| 33 | A C | 15.27 | 10.0 | 222.13 | 1.53 |
| 34 | G | 11.67 | 10.0 | 241.33 | 1.17 |
| 35 | A C F H | 17.13 | 10.0 | 243.47 | 1.71 |
| 36 | A B G I | 18.70 | 11.0 | 210.00 | 1.70 |
| 37 | G | 10.93 | 11.0 | 249.87 | 0.99 |
| 38 | A H | 4.33 | 11.0 | 285.07 | 0.39 |
| 39 | F I | 6.82 | 11.0 | 206.13 | 0.62 |
| 40 | A F H | 11.60 | 12.0 | 272.27 | 0.97 |
| 41 | A B F I | 10.64 | 12.0 | 227.47 | 0.89 |
| 42 | A H | 21.84 | 12.0 | 232.80 | 1.82 |
| 43 | A G | 8.56 | 12.0 | 236.00 | 0.71 |
| 44 | B F H | 0.78 | 12.0 | 263.50 | 0.07 |
| 45 | A F | 10.00 | 12.5 | 200.00 | 0.80 |
| 46 | A B G H I | 15.25 | 12.5 | 268.00 | 1.22 |
| 47 | B | 19.92 | 12.5 | 279.73 | 1.59 |
| 48 | A B F | 15.92 | 12.5 | 316.00 | 1.27 |
| 49 | A B | 6.25 | 12.5 | 270.13 | 0.50 |
| 50 | A F H | 18.42 | 12.5 | 211.47 | 1.47 |
| 51 | F G | 24.25 | 12.5 | 215.73 | 1.94 |
| 52 | A B H | 19.50 | 13.0 | 287.20 | 1.50 |
| 53 | H | 10.66 | 13.0 | 234.93 | 0.82 |
| 54 | B | 14.99 | 13.0 | 326.67 | 1.15 |
| 55 | I | 18.11 | 13.0 | 239.20 | 1.39 |
| 56 | A B F H | 23.49 | 13.0 | 225.33 | 1.81 |
| 57 | A F G H | 10.49 | 13.0 | 302.13 | 0.81 |
| 58 | B I | 3.38 | 13.0 | 231.73 | 0.26 |
| 59 | A B G | 13.95 | 13.0 | 212.53 | 1.07 |
| 60 | A B H | 10.14 | 13.0 | 255.20 | 0.78 |
| 61 | F | 10.80 | 13.5 | 215.00 | 0.80 |
| 62 | A H I | 19.35 | 13.5 | 198.67 | 1.43 |
| 63 | B F | 15.39 | 13.5 | 220.00 | 1.14 |
| 64 | A G H I | 7.83 | 13.5 | 207.20 | 0.58 |
| 65 | B H | 10.30 | 13.5 | 235.70 | 0.76 |
| 66 | A B | 23.49 | 13.5 | 237.07 | 1.74 |
| 67 | A H | 22.05 | 13.5 | 238.13 | 1.63 |
| 68 | F G | 13.08 | 13.5 | 192.00 | 0.97 |
| 69 | A B F | 6.03 | 13.5 | 195.47 | 0.45 |
| 70 | A F | 13.23 | 13.5 | 200.80 | 0.98 |
| 71 | B H | 16.89 | 14.0 | 201.87 | 1.21 |
| 72 | B I | 22.68 | 14.0 | 254.13 | 1.62 |
| 73 | A B F H | 24.17 | 14.0 | 269.07 | 1.73 |
| 74 | B E G | 19.69 | 14.0 | 301.07 | 1.41 |
| 75 | A | 12.60 | 14.0 | 223.20 | 0.90 |
| 76 | H I | 23.30 | 15.0 | 214.67 | 1.55 |
| 77 | A B E G H | 10.30 | 15.0 | 248.80 | 0.69 |
| 78 | A B E H | 17.90 | 15.0 | 288.27 | 1.19 |
| 79 | F G | 21.23 | 16.0 | 246.67 | 1.33 |
| 80 | A E | 8.64 | 16.0 | 290.40 | 0.54 |
| 81 | E G | 17.60 | 16.0 | 207.00 | 1.10 |
| 82 | A E | 25.20 | 18.0 | 230.00 | 1.40 |
| 83 | F | 19.80 | 18.0 | 225.00 | 1.10 |
| 84 | A G | 6.84 | 18.0 | 263.73 | 0.38 |
| 85 | A E | 35.64 | 18.0 | 221.00 | 1.98 |
| 86 | A E | 6.17 | 20.0 | 297.03 | 0.31 |
| 87 | F | 30.55 | 21.0 | 259.78 | 1.45 |
| 88 | A D | 10.99 | 22.0 | 252.33 | 0.50 |
| 89 | A E | 21.50 | 22.0 | 237.43 | 0.98 |
| 90 | D | 14.29 | 24.0 | 222.53 | 0.60 |
| 91 | D E | 25.75 | 24.0 | 319.38 | 1.07 |
| 92 | D E | 3.41 | 29.0 | 267.23 | 0.12 |
| 93 | D | 39.42 | 29.0 | 304.48 | 1.36 |
| 94 | E | 38.55 | 33.0 | 282.13 | 1.17 |
| 95 | D | 51.16 | 33.0 | 229.98 | 1.55 |
| 96 | D E | 44.23 | 35.0 | 215.08 | 1.26 |
| 97 | E | 24.18 | 35.0 | 311.93 | 0.69 |
| 98 | D | 8.53 | 40.0 | 207.63 | 0.21 |
| 99 | D | 31.45 | 40.0 | 274.68 | 0.79 |
| 100 | D | 18.19 | 45.0 | 334.28 | 0.40 |
| 101 | D | 42.32 | 48.0 | 192.73 | 0.88 |
| 102 | D | 90.00 | 50.0 | 244.88 | 1.80 |

TABLE 2

| Designator for | |
|---|---|
| TABLE 1 | Aircraft Type |
| A | Narrow Body, twin engine |
| B | Narrow Body, 4 engines |
| C | Narrow Body, distributed propulsors (>4 engines) |
| D | Wide Body, twin engine |
| E | Wide Body, 4 engines |
| F | Wide Body, distributed propulsors (>4 engines) |
| G | Regional Jet |
| H | Business Jet |
| I | UAV |

For Aircraft Type A, B, C and G having a Mach flight speed at cruise conditions of between 0.70 and 0.85 the fan diameter (D) is between 8 and 16 feet, or more preferably between 12 feet and 16 feet.

TABLES 3-6 provide exemplary embodiments for EORL and D for each of the first ellipse E1, second ellipse E2, third ellipse E3 and fourth ellipse E4, respectively, relative to the quarter chord point (QC).

TABLE 3
First Ellipse E1 Embodiments

| | | EORL | 1MajAL | 1MinAL | | | |
|---|---|---|---|---|---|---|---|
| D (ft) | θ (deg) | (ft) | (ft) | (ft) | EORL/D | 1MajAL/D | 1MinAL/D |
| 2 | 253.6 | 1.876 | 5.6 | 3.4 | 0.938 | 2.8 | 1.7 |
| 3 | 253.6 | 2.814 | 8.4 | 5.1 | 0.938 | 2.8 | 1.7 |
| 4 | 253.6 | 3.752 | 11.2 | 6.8 | 0.938 | 2.8 | 1.7 |
| 5 | 253.6 | 4.69 | 14 | 8.5 | 0.938 | 2.8 | 1.7 |
| 6 | 253.6 | 5.628 | 16.8 | 10.2 | 0.938 | 2.8 | 1.7 |
| 7 | 253.6 | 6.566 | 19.6 | 11.9 | 0.938 | 2.8 | 1.7 |
| 8 | 253.6 | 7.504 | 22.4 | 13.6 | 0.938 | 2.8 | 1.7 |
| 9 | 253.6 | 8.442 | 25.2 | 15.3 | 0.938 | 2.8 | 1.7 |
| 10 | 253.6 | 9.38 | 28 | 17 | 0.938 | 2.8 | 1.7 |
| 11 | 253.6 | 10.318 | 30.8 | 18.7 | 0.938 | 2.8 | 1.7 |
| 12 | 253.6 | 11.256 | 33.6 | 20.4 | 0.938 | 2.8 | 1.7 |
| 12.5 | 253.6 | 11.725 | 35 | 21.25 | 0.938 | 2.8 | 1.7 |
| 13 | 253.6 | 12.194 | 36.4 | 22.1 | 0.938 | 2.8 | 1.7 |
| 13.5 | 253.6 | 12.663 | 37.8 | 22.95 | 0.938 | 2.8 | 1.7 |
| 14 | 253.6 | 13.132 | 39.2 | 23.8 | 0.938 | 2.8 | 1.7 |
| 15 | 253.6 | 14.07 | 42 | 25.5 | 0.938 | 2.8 | 1.7 |
| 16 | 253.6 | 15.008 | 44.8 | 27.2 | 0.938 | 2.8 | 1.7 |
| 18 | 253.6 | 16.884 | 50.4 | 30.6 | 0.938 | 2.8 | 1.7 |
| 20 | 253.6 | 18.76 | 56 | 34 | 0.938 | 2.8 | 1.7 |
| 21 | 253.6 | 19.698 | 58.8 | 35.7 | 0.938 | 2.8 | 1.7 |
| 22 | 253.6 | 20.636 | 61.6 | 37.4 | 0.938 | 2.8 | 1.7 |
| 24 | 253.6 | 22.512 | 67.2 | 40.8 | 0.938 | 2.8 | 1.7 |
| 29 | 253.6 | 27.202 | 81.2 | 49.3 | 0.938 | 2.8 | 1.7 |
| 33 | 253.6 | 30.954 | 92.4 | 56.1 | 0.938 | 2.8 | 1.7 |
| 35 | 253.6 | 32.83 | 98 | 59.5 | 0.938 | 2.8 | 1.7 |
| 40 | 253.6 | 37.52 | 112 | 68 | 0.938 | 2.8 | 1.7 |
| 45 | 253.6 | 42.21 | 126 | 76.5 | 0.938 | 2.8 | 1.7 |
| 48 | 253.6 | 45.024 | 134.4 | 81.6 | 0.938 | 2.8 | 1.7 |
| 50 | 253.6 | 46.9 | 140 | 85 | 0.938 | 2.8 | 1.7 |

TABLE 4
Second Ellipse E2 Embodiments

| | | EORL | 2MajAL | 2MinA | | | |
|---|---|---|---|---|---|---|---|
| D (ft) | θ (deg) | (ft) | (ft) | L (ft) | EORL/D | 2MajAL/D | 2MinAL/D |
| 2 | 248.8 | 2.102 | 3.72 | 3.12 | 1.051 | 1.86 | 1.56 |
| 3 | 248.8 | 3.153 | 5.58 | 4.68 | 1.051 | 1.86 | 1.56 |
| 4 | 248.8 | 4.204 | 7.44 | 6.24 | 1.051 | 1.86 | 1.56 |
| 5 | 248.8 | 5.255 | 9.3 | 7.8 | 1.051 | 1.86 | 1.56 |
| 6 | 248.8 | 6.306 | 11.16 | 9.36 | 1.051 | 1.86 | 1.56 |
| 7 | 248.8 | 7.357 | 13.02 | 10.92 | 1.051 | 1.86 | 1.56 |
| 8 | 248.8 | 8.408 | 14.88 | 12.48 | 1.051 | 1.86 | 1.56 |
| 9 | 248.8 | 9.459 | 16.74 | 14.04 | 1.051 | 1.86 | 1.56 |
| 10 | 248.8 | 10.51 | 18.6 | 15.6 | 1.051 | 1.86 | 1.56 |
| 11 | 248.8 | 11.561 | 20.46 | 17.16 | 1.051 | 1.86 | 1.56 |
| 12 | 248.8 | 12.612 | 22.32 | 18.72 | 1.051 | 1.86 | 1.56 |
| 12.5 | 248.8 | 13.1375 | 23.25 | 19.5 | 1.051 | 1.86 | 1.56 |
| 13 | 248.8 | 13.663 | 24.18 | 20.28 | 1.051 | 1.86 | 1.56 |
| 13.5 | 248.8 | 14.1885 | 25.11 | 21.06 | 1.051 | 1.86 | 1.56 |
| 14 | 248.8 | 14.714 | 26.04 | 21.84 | 1.051 | 1.86 | 1.56 |
| 15 | 248.8 | 15.765 | 27.9 | 23.4 | 1.051 | 1.86 | 1.56 |
| 16 | 248.8 | 16.816 | 29.76 | 24.96 | 1.051 | 1.86 | 1.56 |
| 18 | 248.8 | 18.918 | 33.48 | 28.08 | 1.051 | 1.86 | 1.56 |
| 20 | 248.8 | 21.02 | 37.2 | 31.2 | 1.051 | 1.86 | 1.56 |
| 21 | 248.8 | 22.071 | 39.06 | 32.76 | 1.051 | 1.86 | 1.56 |
| 22 | 248.8 | 23.122 | 40.92 | 34.32 | 1.051 | 1.86 | 1.56 |
| 24 | 248.8 | 25.224 | 44.64 | 37.44 | 1.051 | 1.86 | 1.56 |
| 29 | 248.8 | 30.479 | 53.94 | 45.24 | 1.051 | 1.86 | 1.56 |
| 33 | 248.8 | 34.683 | 61.38 | 51.48 | 1.051 | 1.86 | 1.56 |
| 35 | 248.8 | 36.785 | 65.1 | 54.6 | 1.051 | 1.86 | 1.56 |
| 40 | 248.8 | 42.04 | 74.4 | 62.4 | 1.051 | 1.86 | 1.56 |
| 45 | 248.8 | 47.295 | 83.7 | 70.2 | 1.051 | 1.86 | 1.56 |
| 48 | 248.8 | 50.448 | 89.28 | 74.88 | 1.051 | 1.86 | 1.56 |
| 50 | 248.8 | 52.55 | 93 | 78 | 1.051 | 1.86 | 1.56 |

TABLE 5
Third Ellipse E3 Embodiments

| | | | 3MajAL | 3MinAL | | | |
|---|---|---|---|---|---|---|---|
| D (ft) | θ (deg) | EORL (ft) | (ft) | (ft) | EORL/D | 3MajAL/D | 3MinAL/D |
| 2 | 239.6 | 1.74 | 2.8 | 1.8 | 0.87 | 1.4 | 0.9 |
| 3 | 239.6 | 2.61 | 4.2 | 2.7 | 0.87 | 1.4 | 0.9 |
| 4 | 239.6 | 3.48 | 5.6 | 3.6 | 0.87 | 1.4 | 0.9 |
| 5 | 239.6 | 4.35 | 7 | 4.5 | 0.87 | 1.4 | 0.9 |
| 6 | 239.6 | 5.22 | 8.4 | 5.4 | 0.87 | 1.4 | 0.9 |
| 7 | 239.6 | 6.09 | 9.8 | 6.3 | 0.87 | 1.4 | 0.9 |
| 8 | 239.6 | 6.96 | 11.2 | 7.2 | 0.87 | 1.4 | 0.9 |
| 9 | 239.6 | 7.83 | 12.6 | 8.1 | 0.87 | 1.4 | 0.9 |
| 10 | 239.6 | 8.7 | 14 | 9 | 0.87 | 1.4 | 0.9 |
| 11 | 239.6 | 9.57 | 15.4 | 9.9 | 0.87 | 1.4 | 0.9 |
| 12 | 239.6 | 10.44 | 16.8 | 10.8 | 0.87 | 1.4 | 0.9 |
| 12.5 | 239.6 | 10.875 | 17.5 | 11.25 | 0.87 | 1.4 | 0.9 |
| 13 | 239.6 | 11.31 | 18.2 | 11.7 | 0.87 | 1.4 | 0.9 |
| 13.5 | 239.6 | 11.745 | 18.9 | 12.15 | 0.87 | 1.4 | 0.9 |
| 14 | 239.6 | 12.18 | 19.6 | 12.6 | 0.87 | 1.4 | 0.9 |
| 15 | 239.6 | 13.05 | 21 | 13.5 | 0.87 | 1.4 | 0.9 |
| 16 | 239.6 | 13.92 | 22.4 | 14.4 | 0.87 | 1.4 | 0.9 |
| 18 | 239.6 | 15.66 | 25.2 | 16.2 | 0.87 | 1.4 | 0.9 |
| 20 | 239.6 | 17.4 | 28 | 18 | 0.87 | 1.4 | 0.9 |
| 21 | 239.6 | 18.27 | 29.4 | 18.9 | 0.87 | 1.4 | 0.9 |
| 22 | 239.6 | 19.14 | 30.8 | 19.8 | 0.87 | 1.4 | 0.9 |
| 24 | 239.6 | 20.88 | 33.6 | 21.6 | 0.87 | 1.4 | 0.9 |
| 29 | 239.6 | 25.23 | 40.6 | 26.1 | 0.87 | 1.4 | 0.9 |
| 33 | 239.6 | 28.71 | 46.2 | 29.7 | 0.87 | 1.4 | 0.9 |
| 35 | 239.6 | 30.45 | 49 | 31.5 | 0.87 | 1.4 | 0.9 |
| 40 | 239.6 | 34.8 | 56 | 36 | 0.87 | 1.4 | 0.9 |
| 45 | 239.6 | 39.15 | 63 | 40.5 | 0.87 | 1.4 | 0.9 |
| 48 | 239.6 | 41.76 | 67.2 | 43.2 | 0.87 | 1.4 | 0.9 |
| 50 | 239.6 | 43.5 | 70 | 45 | 0.87 | 1.4 | 0.9 |

TABLE 6
Fourth Ellipse E4 Embodiments

| | | EORL | 4MajAL | 4MinAL | | | |
|---|---|---|---|---|---|---|---|
| D (ft) | θ (deg) | (ft) | (ft) | (ft) | EORL/D | 4MajAL/D | 4MinAL/D |
| 2 | 235.7 | 1.526 | 1.88 | 0.88 | 0.763 | 0.94 | 0.44 |
| 3 | 235.7 | 2.289 | 2.82 | 1.32 | 0.763 | 0.94 | 0.44 |
| 4 | 235.7 | 3.052 | 3.76 | 1.76 | 0.763 | 0.94 | 0.44 |
| 5 | 235.7 | 3.815 | 4.7 | 2.2 | 0.763 | 0.94 | 0.44 |
| 6 | 235.7 | 4.578 | 5.64 | 2.64 | 0.763 | 0.94 | 0.44 |
| 7 | 235.7 | 5.341 | 6.58 | 3.08 | 0.763 | 0.94 | 0.44 |
| 8 | 235.7 | 6.104 | 7.52 | 3.52 | 0.763 | 0.94 | 0.44 |
| 9 | 235.7 | 6.867 | 8.46 | 3.96 | 0.763 | 0.94 | 0.44 |
| 10 | 235.7 | 7.63 | 9.4 | 4.4 | 0.763 | 0.94 | 0.44 |
| 11 | 235.7 | 8.393 | 10.34 | 4.84 | 0.763 | 0.94 | 0.44 |
| 12 | 235.7 | 9.156 | 11.28 | 5.28 | 0.763 | 0.94 | 0.44 |
| 12.5 | 235.7 | 9.5375 | 11.75 | 5.5 | 0.763 | 0.94 | 0.44 |
| 13 | 235.7 | 9.919 | 12.22 | 5.72 | 0.763 | 0.94 | 0.44 |
| 13.5 | 235.7 | 10.3005 | 12.69 | 5.94 | 0.763 | 0.94 | 0.44 |
| 14 | 235.7 | 10.682 | 13.16 | 6.16 | 0.763 | 0.94 | 0.44 |
| 15 | 235.7 | 11.445 | 14.1 | 6.6 | 0.763 | 0.94 | 0.44 |
| 16 | 235.7 | 12.208 | 15.04 | 7.04 | 0.763 | 0.94 | 0.44 |
| 18 | 235.7 | 13.734 | 16.92 | 7.92 | 0.763 | 0.94 | 0.44 |
| 20 | 235.7 | 15.26 | 18.8 | 8.8 | 0.763 | 0.94 | 0.44 |
| 21 | 235.7 | 16.023 | 19.74 | 9.24 | 0.763 | 0.94 | 0.44 |
| 22 | 235.7 | 16.786 | 20.68 | 9.68 | 0.763 | 0.94 | 0.44 |
| 24 | 235.7 | 18.312 | 22.56 | 10.56 | 0.763 | 0.94 | 0.44 |
| 29 | 235.7 | 22.127 | 27.26 | 12.76 | 0.763 | 0.94 | 0.44 |
| 33 | 235.7 | 25.179 | 31.02 | 14.52 | 0.763 | 0.94 | 0.44 |
| 35 | 235.7 | 26.705 | 32.9 | 15.4 | 0.763 | 0.94 | 0.44 |
| 40 | 235.7 | 30.52 | 37.6 | 17.6 | 0.763 | 0.94 | 0.44 |
| 45 | 235.7 | 34.335 | 42.3 | 19.8 | 0.763 | 0.94 | 0.44 |
| 48 | 235.7 | 36.624 | 45.12 | 21.12 | 0.763 | 0.94 | 0.44 |
| 50 | 235.7 | 38.15 | 47 | 22 | 0.763 | 0.94 | 0.44 |

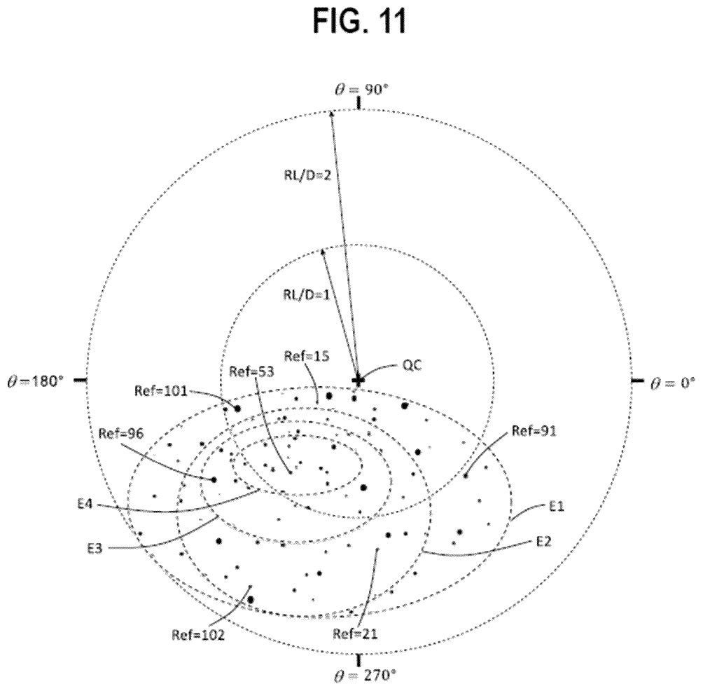

Referring to FIG. 8, the locations for P relative to the airfoil section and advantages therefrom described above can also be realized for an unducted fan propulsor system mounted above a horizontal stabilizer. For an unducted fan propulsor mounted to horizontal stabilizers, the foregoing examples and embodiments would be mirrored about the chord line of the airfoil section (again, for purposes of explanation, this chord line may be thought of as an axis passing through θ=0 deg and θ=180 deg in FIG. 11) for the case where the airfoil section 41 produces a lift in the downward direction, such as a horizontal stabilizer, as compared to a wing which produces a lift in the upward direction. The above descriptions for an undermount propulsor can apply, with the location being shifted as shown in FIG. 8 as compared to FIG. 7.

According to the foregoing examples or embodiments, the unducted fan propulsor 38, incorporating the vane assembly described herein, can be incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9. A propulsor that is part of an airplane that operates at a high cruise flight Mach number (e.g., greater than 0.7) encounters velocities near the surfaces of the rotor, vanes, and nacelle that approach or exceed the speed of sound, or Mach 1.0. In general, friction drag increases roughly in proportion to the square of the air velocity. However, as the Mach number increases, a significant contributor to the increase in drag can come from wave drag. Wave drag is a drag resulting from shock waves that form as the flow of air near a surface becomes supersonic (e.g., Mach>1.0).

In addition to the cruise flight Mach number, another factor contributing to increased drag on propulsor surfaces is high non-dimensional cruise fan net thrust based on fan annular area and flight speed. The same acceleration of the air stream by the fan that produces thrust also tends to increase the drag force on the rotor, vanes, and nacelle.

Expressing thrust non-dimensionally in a way that accounts for flight speed, ambient conditions, and fan annular area yields a thrust parameter as follows:

$$\frac{{F}_{net}}{{ρ}_{0} {A}_{an} {V}_{0}^{2}}$$

In the above thrust parameter, Fₙₑₜ is cruise fan net thrust, ρ₀ is ambient air density, Vₒ is cruise flight velocity, and Aₐₙ is fan stream tube cross-sectional area at the fan inlet. Fan annular area, Aₐₙ, is computed using a maximum radius as the tip radius of the forward-most rotor blades and a minimum radius as the minimum radius of the fan stream tube entering the fan.

A propulsor that operates at a high cruise fan net thrust parameter (e.g., greater than 0.06) tends to have higher propulsor velocities with risk of higher drag on propulsor surfaces.

According to any of the foregoing examples or embodiments, there may be a particularly beneficial range of a dimensionless cruise fan net thrust parameter normalized by ambient density, cruise flight speed squared, and fan stream tube annular area at fan inlet defined by the following expression:

$$0.15 > \frac{{F}_{net}}{{ρ}_{0} {A}_{an} {V}_{0}^{2}} > 0.06$$

Both a high cruise flight Mach and high dimensionless cruise fan net thrust parameter contribute to higher drag levels on the propulsor surfaces. Advantageously, the specific unducted fan propulsor positions relative to the wing airfoil section, as described herein, can increase unducted fan propulsor net thrust for a given power input when there is a high cruise flight Mach and a high dimensionless cruise fan net thrust parameter.

Using the conditions described herein, the specific regions for placing the unducted fan propulsor system can be located where there is a relatively higher pressure on the high pressure side of the airfoil, beneath the wings or above the horizontal stabilizers. The higher pressure provides increased thrust from the unducted fan propulsor to thereby offset drag penalties resulting from the installation of unducted fan propulsors.

The foregoing conditions for the placement of the propulsors relative to the wing airfoils can be present for any mounting configuration of the propulsors wing. While the mounting configuration can be fixed, it is contemplated that the mounting configuration could be variable. For example, the mounting configuration of an unducted fan propulsor relative to a wing could be different for takeoff as compared to cruise operating conditions. In such a scenario, the foregoing conditions for placement of the propulsors relative to the wing airfoils can be present in either or both operating conditions, or any other operating condition.

The features described above for positioning an unducted fan propulsor relative to the aircraft wing by defining a P location between external OGV or IGV and a forward or aft rotating array of fan blades, respectively, and/or defining the distance from the effective QC to P, results in improved installed performance of the unducted fan propulsor by increasing thrust due to higher pressure air on the pressure side of the wing airfoil. However, installing an unducted fan propulsor in this position may result in increased distortion of the flow field. In particular, as the unducted fan propulsor is positioned closer to the wing, the unducted fan propulsor is positioned closer to the upwash field and experiences more wing-induced distortion. The wing-induced distortion may cause increased variation in the swirl across the unducted fan propulsor from the in-board side to the out-board side of the array of blades 34.

The increased variation in swirl may be addressed by an improved design to the leading edge angle of the vanes of the unducted fan propulsor to counteract the increased distortion. The delta in a leading edge angle from an average leading edge angle may vary from

$$9 * cos ( 0.8 * Φ + \frac{π}{5} ) + 7.9 to 3.5 * cos ( Φ ) - 7.5$$

for a broader band of variation in the delta in the leading edge angle, and from

$$7 * cos ( 0.8 * Φ + \frac{π}{5} ) + 5.5 to 5.5 * cos ( Φ ) - 4.5$$

for a narrower band of variation in the delta in the leading edge angle, where Φ is measured relative to the circumferential positioning vector, and where the leading edge angle is measured as an angle between two reference lines as further described below. The improved design of the vanes may straighten the generated swirl to improve the axial thrust produced by the unducted fan propulsor. The resulting combination of the position of the unducted fan propulsor and the design of the leading edge angles of the vanes, as described herein, produces synergistic improvements in thrust efficiency.

In some implementations, the variation in the leading edge angle may further depend on the RL/D described above. There is an advantageous circumferential variation in the leading edge angle which depends on the proximity of the unducted fan propulsor to the wing based on RL/D and the circumferential position. As the unducted fan propulsor approaches closer to the wing, RL/D becomes smaller, and the wing-induced distortion becomes larger. Therefore, the variation in the delta in the leading edge angle may be modified by a factor that depends on RL/D. Therefore, the upper and lower bounds for a range in the variation of the leading edge may change depending on the value of RL/D for the unducted fan propulsor in a particular installed location for an aircraft. The modified upper and lower bounds enable a more efficient design on the leading edge angle of the vanes for a unducted fan propulsor for a particular value of RL/D.

In the case of unducted, open fan gas turbine engines, the flow entering the vanes is less uniform than for ducted engines. Furthermore, the impact of the vanes can vary depending upon differences in angle of attack, such as cruise versus take-off angles of attack.

The following disclosure is generally related to a vane assembly for an open fan engine having a rotor and stator. The stator includes a vane assembly with a plurality of vanes. Each of the vanes of the vane assembly has a leading edge (LE) with a leading edge angle (LEA). A combination of aircraft angle of attack, sideslip, and upwash due to lifting bodies can create a flow angularity into the engine, where this flow angularity would vary for different flight conditions. This flow angularity translates to a circumferential variation, or distortion, in the flow field entering the stationary vane row. The conventional approach would be to configure the vanes to operate efficiently or with little flow separation at a design point (e.g. cruise) where there is very little or no flow angularity. At high flow angularities, the vanes configured for a design point can have increased losses due to distortion in the flow entering the vanes. It would be useful if there were a way to also achieve high performance at high flow angularity.

The description herein describes how the leading edge angles of the vanes can vary depending upon the circumferential location about the engine. The circumferential variation in leading edge angle (LEA) could provide aircraft system benefits and efficiency, such as maintaining thrust at takeoff, reduced fuel burn over the mission, reduced aeromechanics risk, and/or reduced noise generation.

In some implementations, the circumferential variation in the LEA may be applied to all the vanes in the vane assembly of the unducted fan propulsor. In other implementations, the circumferential variation in the LEA may be applied to at least 50% the vanes in the vane assembly of the unducted fan propulsor. In other implementations, the circumferential variation in the LEA may be applied to at least 75% the vanes in the vane assembly of the unducted fan propulsor. In yet other implementations, the circumferential variation in the LEA may be applied to a different percentage of the vanes in the vane assembly of the unducted fan propulsor.

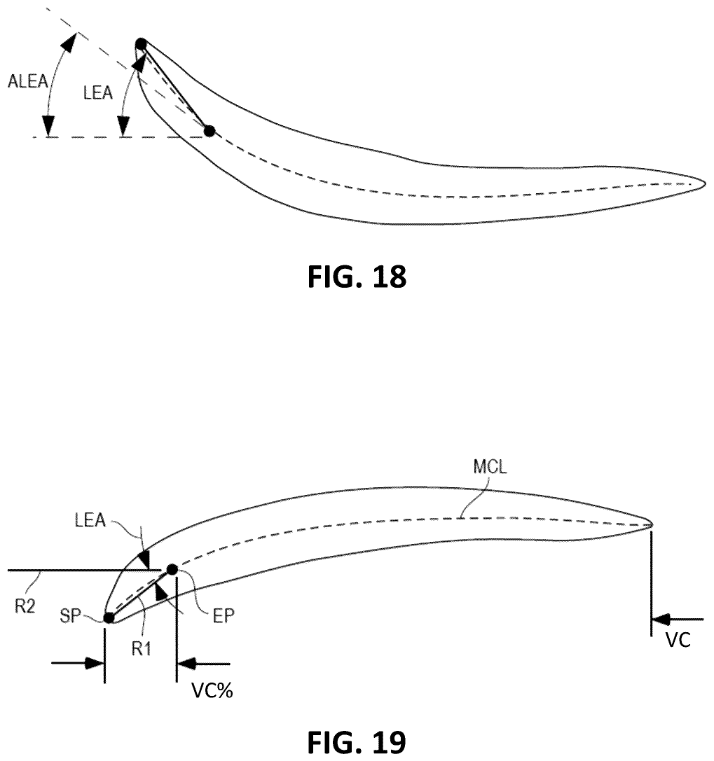

Referring back to FIG. 3, the unducted fan propulsor 38 takes the form of an open rotor propulsion system and has a rotating element in the form of rotatable propeller assembly or rotor 32 on which is circumferentially mounted a first array of blades 34 around a rotor axis of rotation RAR, which is also the axial centerline (CL) in this example, of the unducted fan propulsor 38. The unducted fan propulsor 38 also includes a non-rotating stationary element, vane assembly 40, which includes an array of circumferentially mounted vanes 42 also disposed around the rotor axis of rotation RAR, as shown in FIG. 12. The number of vanes 42 of the vane assembly 40 can vary. For example, the number of vanes can be 12 as shown, or more (e.g., 16) or less (e.g., 8), or between 8 and 16.

As shown in FIG. 3, the exemplary unducted fan propulsor 38 includes a drive mechanism 44 which provides torque and power to the propeller assembly 32 through a transmission 46. In various embodiments, the drive mechanism 44 may be a gas turbine engine, an electric motor, an internal combustion engine, or any other suitable source of torque and power and may be located in proximity to the propeller assembly 12 or may be remotely located with a suitably configured transmission 18. Transmission 18 transfers power and torque from the drive mechanism 44 to the propeller assembly 12 and may include one or more shafts, gearboxes, or other mechanical or fluid drive systems.

A vane 42 of the vane assembly 40 of FIG. 3 has a leading edge (LE) and a height, as shown in detail in FIG. 27, which can be measured from the root of the vane 42 to the tip. Points along the height of the vane 42 can be identified as different spans. For example, and as shown in FIG. 27, there can be a multitude of spans along the leading edge (LE), e.g., SPANA at a first distance DA from the root, a SPANB at a second distance DB from the root and a SPANC at a third distance DC from the root. For example, the spans can be within regions than include 0-50 or 50-100 percent of vane height as measured from the root of the vane 42 to the tip, in other words, lower half or upper half; or, for example, 10-90, 20-80, 30-70, 40-60 percent of the vane height as measured from the root of the vane 42 to the tip, or just a single span that meets the criteria. There can be many different spans identified. Such variation in leading edge angle (LEA) could be particularly beneficial over certain ranges of the vane height depending upon vane and other design factors, such as where those ranges can vary around the circumference. The purpose of identifying a given span is to identify a common point of measurement for the leading edge angle (LEA) among different vanes 42 of the vane assembly 40.

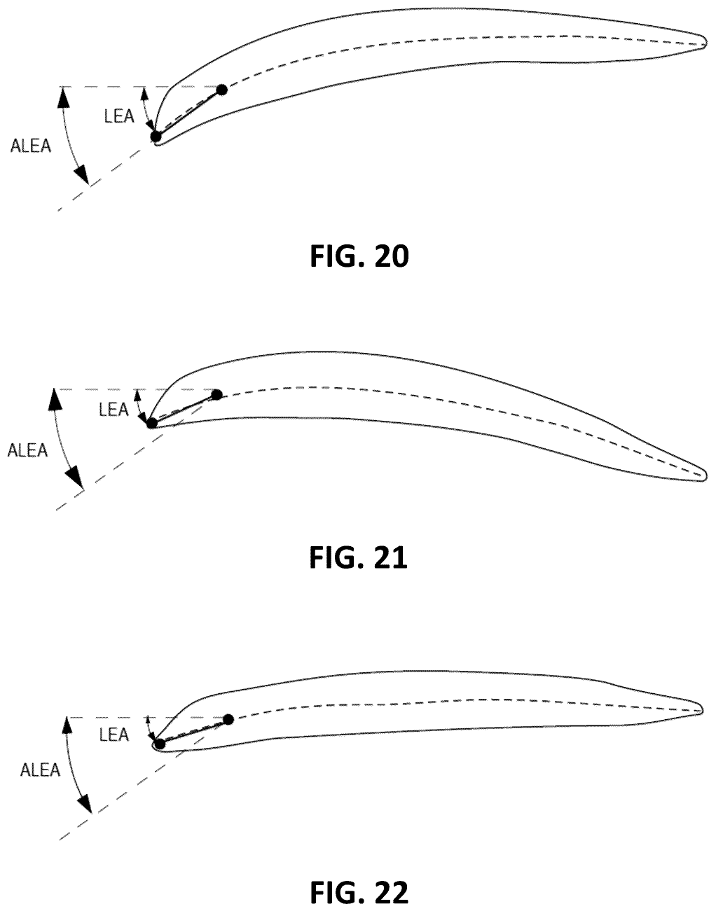

Once a given span is identified, e.g., SPANA, SPANB, SPANC, etc., a comparison of the leading edge angle (LEA) for each of the different vanes 42 of the vane assembly 40 can be made. The leading edge angle (LEA) for a given vane 42 is measured between a first reference line (R1) and a second reference line (R2) at the chosen span, as shown in FIGS. 13 and 19. The first reference line (R1) has a starting point (SP) at the leading edge (LE) of the vane 42 and an ending point (EP) along a mean camber line (MCL) of the vane 42 and at a specific vane chord length percent (VC %) from the leading edge (LE), as shown in FIG. 13 for clockwise rotation of the rotor 32 and FIG. 19 for counter-clockwise rotation of the rotor 32. The specific vane chord length percent (VC %) can be a percent of the total vane chord length (VC) of the vane 42 as measured from the leading edge (LE). For example, the vane chord length percent (VC %) can be 2%, 3%, 5%, or up to 15% of the total vane chord length (VC) of the vane 42. The second reference line (R2) extends forward, from the ending point (EP) of the first reference line (R1) and in a direction toward the leading edge (LE) and parallel to the axis of rotation, as shown in FIG. 13 for clockwise rotation of the rotor 32 and FIG. 19 for counter-clockwise rotation of the rotor 32. The leading edge angle (LEA) can be calculated at any given condition in the case where vanes are subject to re-staggering during operation or otherwise.

The leading edge angle (LEA) for each of the vanes 42 of the vane assembly 40 can be averaged to determine an average leading edge angle (ALEA). The variation or delta in leading edge angle (DLEA), for a given one of the vanes 42 as compared to the average leading edge angle (ALEA) can be determined. If all of the vanes 42 are identical and identically arranged, then each one would have a delta in leading edge angle (DLEA) of zero. However, as discussed above, there are benefits in efficiency that can be achieved by varying the DLEA of the vanes 42 about the circumference of the vane assembly 40.

The position of a given vane 42 about the circumference of the vane assembly 40 can be measured at a different circumferential location Φ, where Φ is measured relative to a circumferential positioning vector (CPV) defined as the cross-product of two vectors, V1×V2, and Φ increases in the direction of rotor rotation.

V1 is a vector of unit magnitude and represents the average flow direction integrated over the disk area of the intended rotor location relative to the aircraft but without the effects of the engine on the flow. For example, as shown in FIG. 28, there can be a variation in flow direction and magnitude across the rotor disk area due to aircraft angle of attack, sideslip, and/or upwash due to lifting bodies, which when integrated across the disk area results in a single vector V1. V2 is aligned with the rotor axis of rotation RAR of the open fan engine and is of unit magnitude, where the direction depends on the rotation direction of the rotor. For clockwise forward looking aft (FLA) rotor rotation, V2 extends from forward to aft along the rotor axis of rotation RAR. For counter-clockwise FLA rotor rotation, V2 extends from aft to forward along the rotor axis of rotation RAR. For example, if there were an upward vertical flow component with no horizontal flow component, as shown in FIGS. 29 and 30, then the CPV would be located along the horizontal pointed towards the left FLA for clockwise FLA rotor rotation and toward the right FLA for counter-clockwise FLA rotor rotation, respectively. In the case where there is no vertical flow component and a horizontal flow component in a direction from left to right FLA, the CPV would be located along the vertical pointed towards the top for clockwise FLA rotor rotation and towards the bottom for counter-clockwise FLA rotor rotation, as shown in FIGS. 31 and 32. In a case where there is an upward vertical flow component and a horizontal flow component in a direction of right to left FLA, the CPV would point from the rotor axis of rotation RAR towards the lower left quadrant FLA for clockwise rotor rotation FLA and would point from the rotor axis of rotation RAR towards the upper right quadrant FLA for counter-clockwise rotor rotation FLA, as shown in FIGS. 33 and 34.

As mentioned above, in one aspect, V1 can be a vector of unit magnitude aligned to the flight direction extending from upstream to downstream. This represents a simplified vector where only the orientation of the engine relative to the flight direction of the aircraft is considered; the wing upwash and other flow effects from the installation are omitted. An example of this simplified V1 can be seen in FIGS. 37 and 38, where FIG. 37 shows a top view of the aircraft and FIG. 38 shows a side elevation view of the aircraft. Based on the flight direction of the aircraft, the simplified V1 vector can be determined, which as shown has an upward and sideslip component relative to the rotor axis of rotation RAR, which in this example coincides with the axial centerline of the engine.

In certain flight conditions, there can be a large vertical flow velocity component. For example, during takeoff there can be a vertical flow velocity component that is much larger than a sideslip component. As an alternative to using CPV based upon V1 and V2, CPV could be defined as a line that extends from the rotor axis of rotation (RAR) horizontally to the left when forward looking aft (FLA) for clockwise rotor rotation FLA and continuing in the direction of rotation and starting from a line that extends from the RAR horizontally to the right when FLA for counter-clockwise rotation FLA and continuing in the direction of rotation. Advantageously, using such an alternative can allow for design of the vane assembly considering a possible critical flight condition.

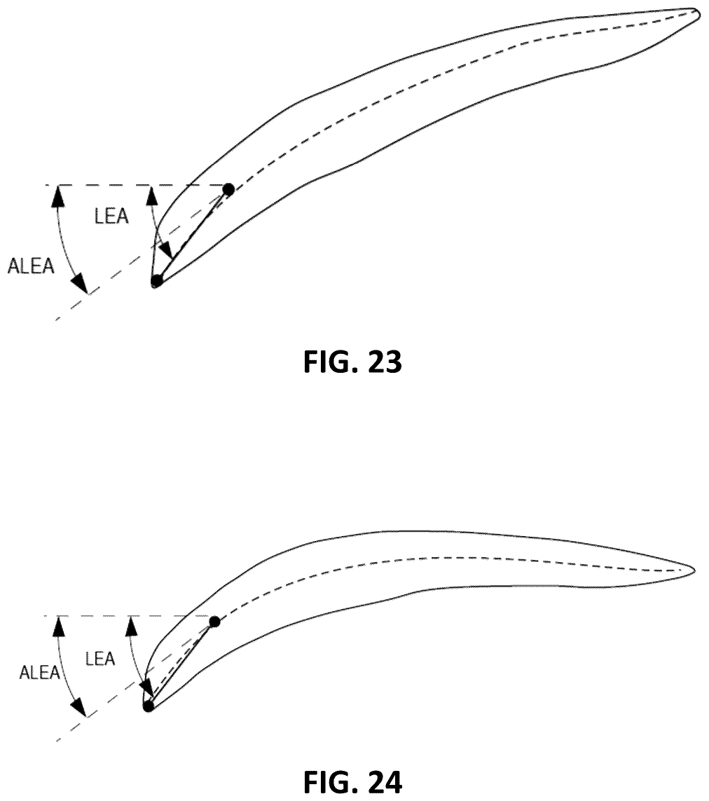

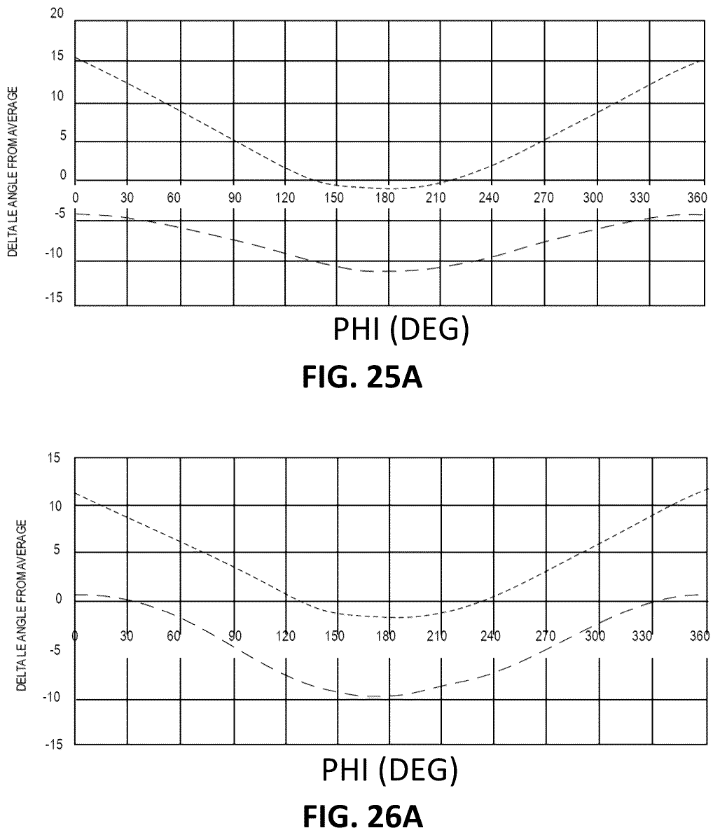

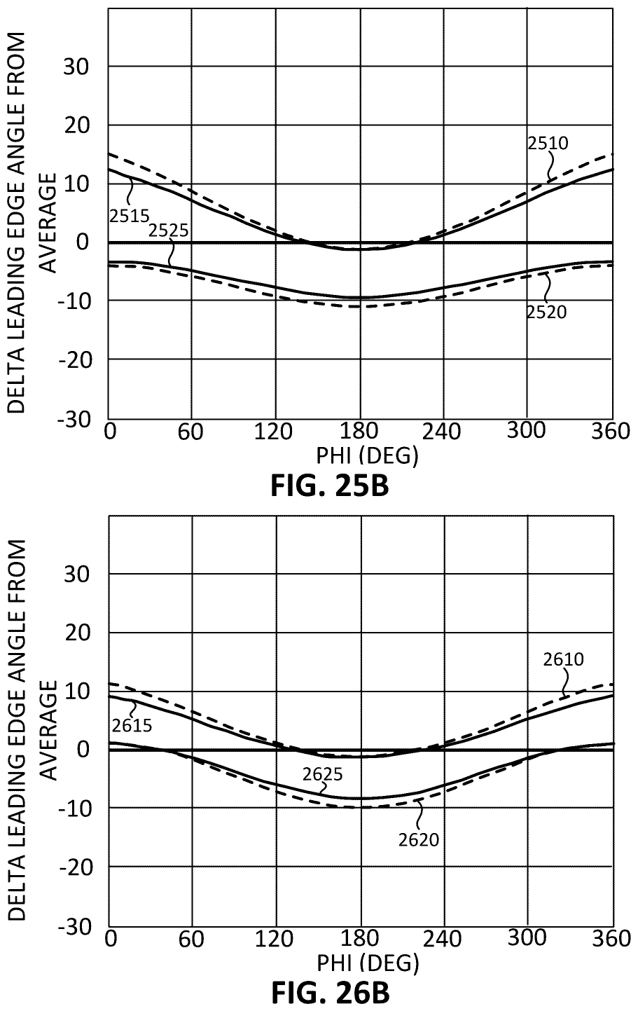

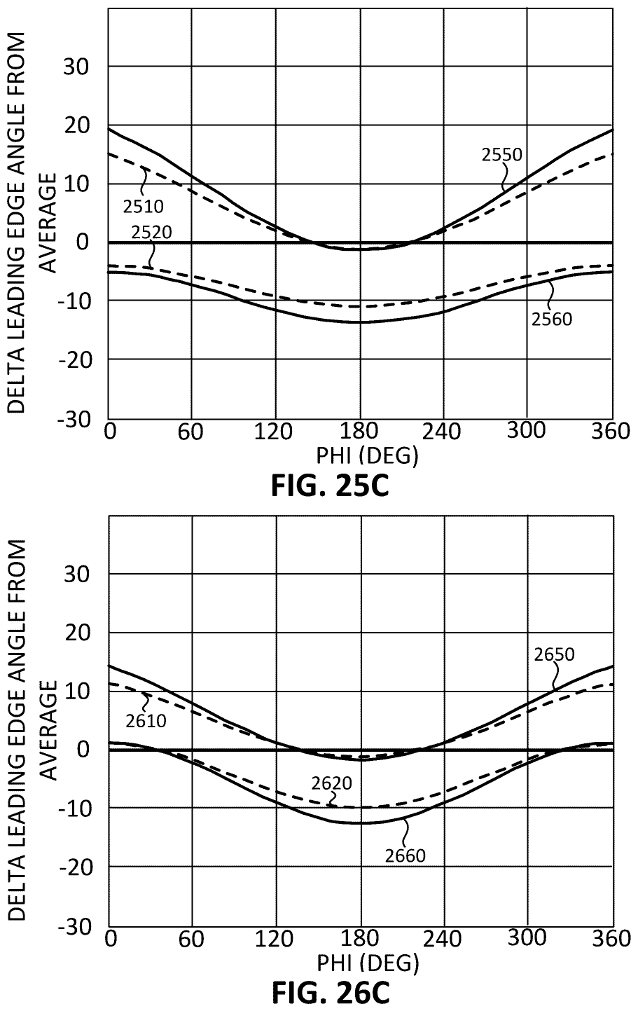

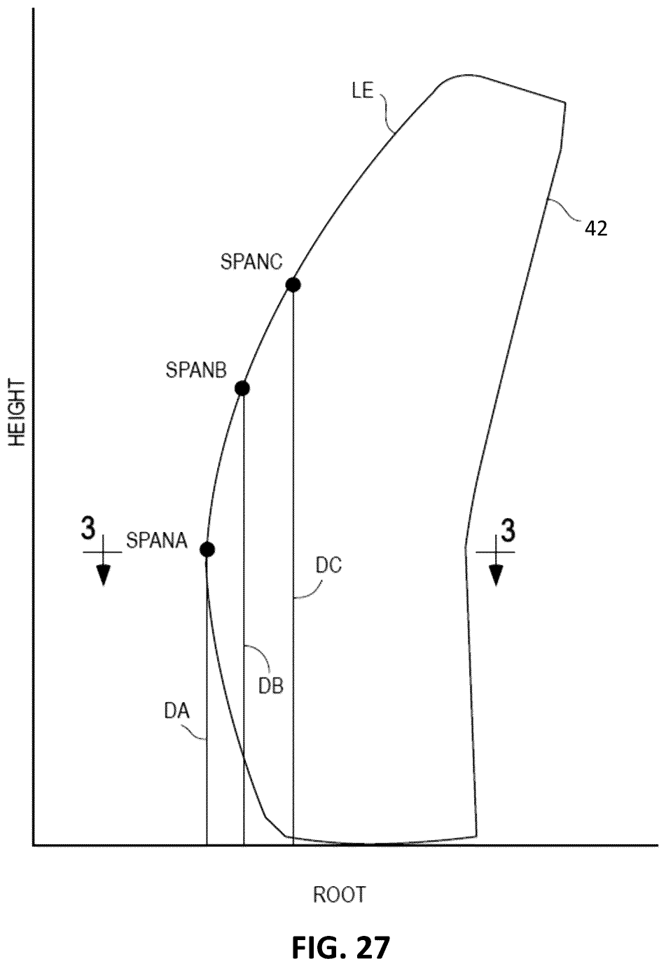

For clockwise rotation of the rotor 32, the vanes 42 of the vane assembly 40 can have a variation in leading edge angle (LEA) relative to the average leading edge angle (ALEA), as shown in FIGS. 13-18. For example, the vane of FIG. 14 has a leading edge angle (LEA) that is the same as the average leading edge angle (ALEA). The vane of FIG. 15 has a leading edge angle (LEA) that is less than the average leading edge angle (ALEA), with the difference achieved by changing the stagger of the vane relative to that of FIG. 14. The vane of FIG. 16 also has a leading edge angle (LEA) that is less than the average leading edge angle (ALEA), but with the difference achieved by changing the camber of the vane relative to that of FIG. 14. The vane of FIG. 17 has a leading edge angle (LEA) that is greater than the average leading edge angle (ALEA), with the difference achieved by changing the stagger of the vane relative to that of FIG. 14. The vane of FIG. 18 also has a leading edge angle (LEA) that is greater than the average leading edge angle (ALEA), but with the difference achieved by changing the camber of the vane relative to that of FIG. 14. Also by way of example, the leading edge angles (LEA) can vary around the circumference by both stagger variation and camber variation as may be suitable improved performance for a given design.

The stagger can be changed, for example, using a vane actuator system. The vane actuator system can adjust some or all of the vanes together or on a more individual basis. Examples of vane actuator systems are disclosed in U.S. Pat. Nos. 9,103,228 and 10,704,411, which are incorporated herein by reference in their entireties.

Another example of a vane actuator system 324 is depicted in FIG. 36, which shows a roll-out view of several of the vanes 42, it being understood that additional vanes or groups of vanes could be incorporated into the system or multiple such systems being included for groups of vanes of a common rotor. The vane actuator system 324 includes a vane trunnion 326 for each of the vanes 42 which can rotate about a central axis, which can be a line that extends from the engine axial centerline to the center of the vane trunnion 326. The vane trunnion 326 is connected to the vane 42 and thus controls the vane stagger as the vane trunnion 326 rotates. The rotation of the vane trunnion 326 is controlled by a kinematic linkage 328. The kinematic linkage 328 rotates about the engine axial centerline, and is controlled by one or more actuators. For a given rotation of the kinematic linkage 328 (or shift to the left or right as shown in the roll-out view of FIG. 36), the vane trunnion 326, and thus the vane 42, rotates some amount ß based on the length L of a trunnion arm 330 extending between the vane trunnion 326 and the kinematic linkage 328. The trunnion arm 330 is pivotable at one end portion relative to the vane trunnion 326 and at another end portion relative to the kinematic linkage 328. The trunnion arms 330 can optionally vary in length. By varying the lengths L of the trunnion arms 330, the change in ß can be varied among the vanes 42 in the vane assembly 40. FIG. 36 shows two different positions, Position 1 and Position 2. Position 1 is some starting position. Position 2 shows the vane stagger having been changed as compared to Position 1. The kinematic linkage 328 has rotated about the engine axial centerline (shifted to the left in the roll-out view), the difference in β based on the variation in length L of the trunnion arms 330. In FIG. 36, L₂ is greater than L₁, and β₂ is less than β₁. The use of such a vane actuator system 324 can beneficially allow for changing the amount of circumferential variation in stagger or LE angle throughout the flight envelope.

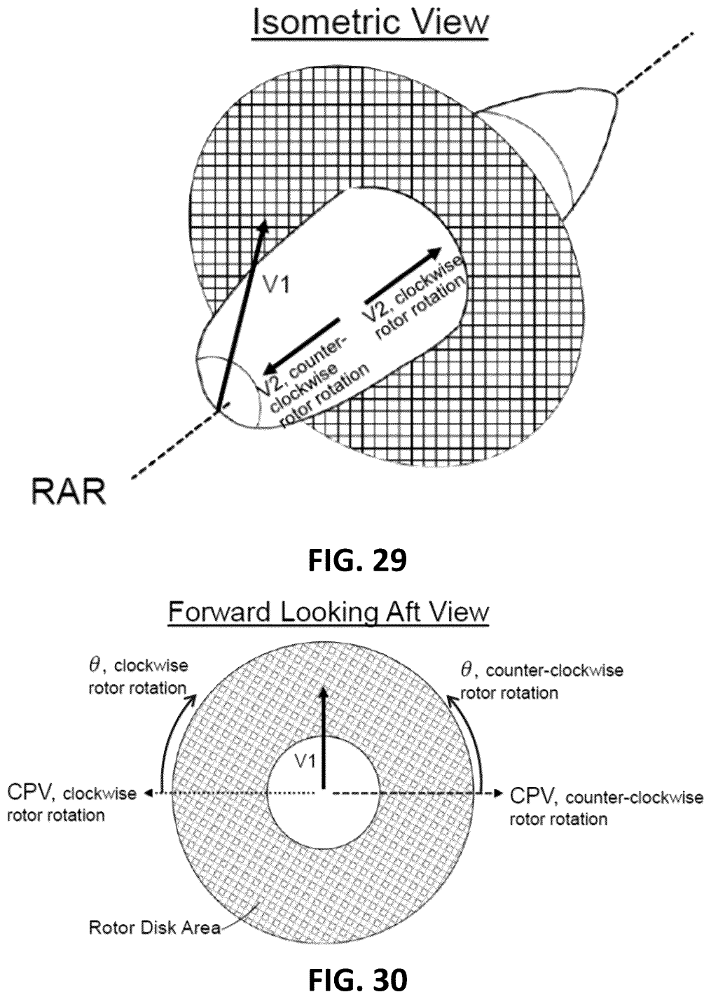

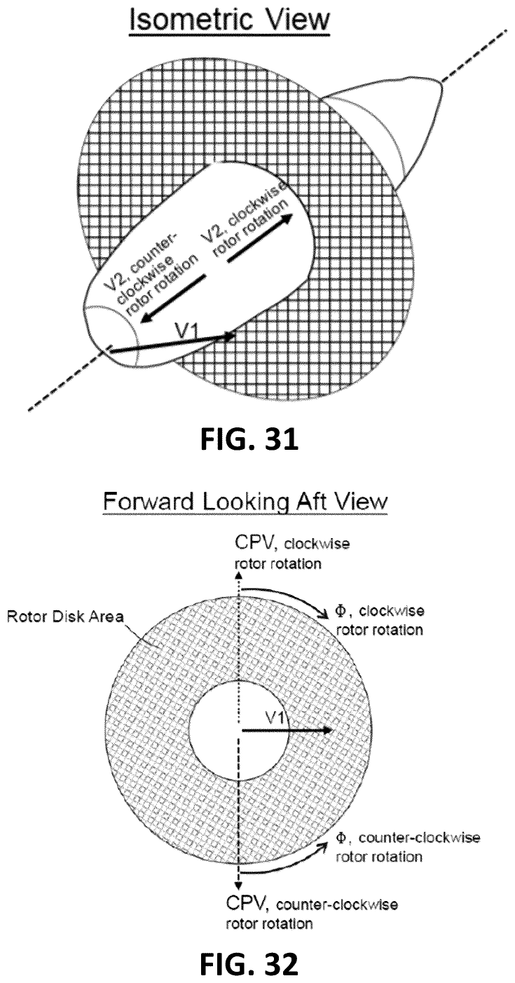

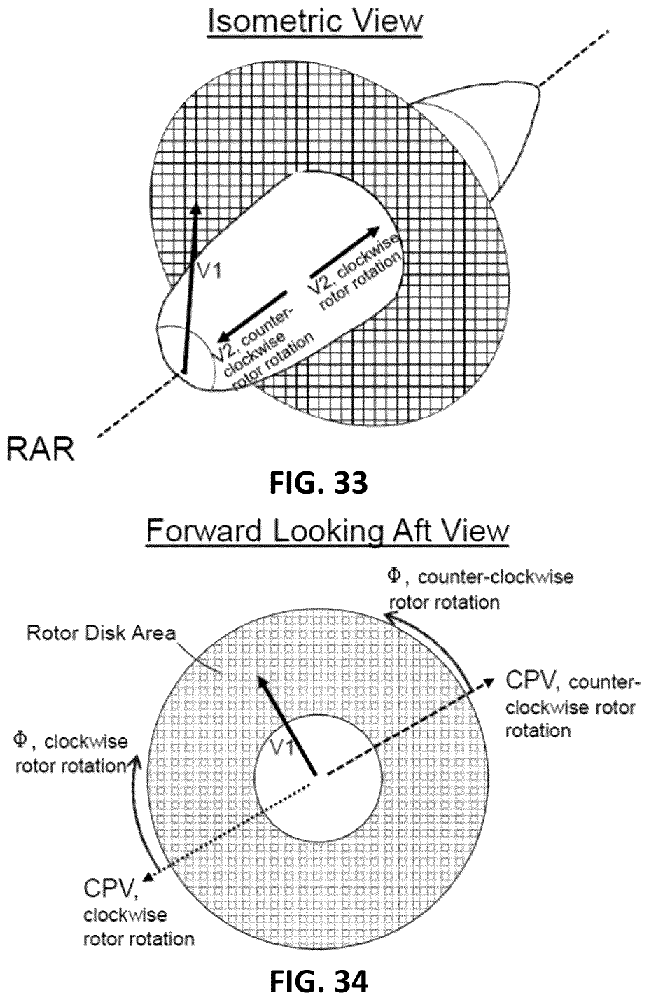

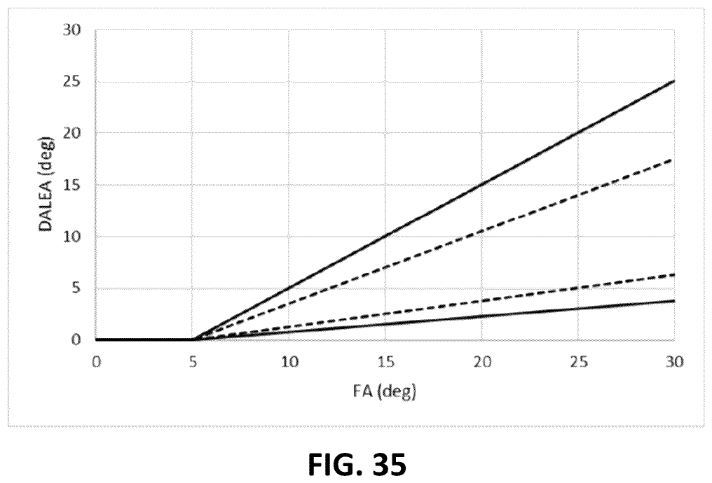

For counter-clockwise rotation of the rotor 32, the vanes 42 of the vane assembly 40 can have a variation in leading edge angle (LEA) relative to the average leading edge angle (ALEA), as shown in FIGS. 19-24. For example, the vane of FIG. 20 has a leading edge angle (LEA) that is the same as the average leading edge angle (ALEA). The vane of FIG. 21 has a leading edge angle (LEA) that is less than the average leading edge angle (ALEA), with the difference achieved by changing the stagger of the vane relative to that of FIG. 20. The vane of FIG. 22 also has a leading edge angle (LEA) that is less than the average leading edge angle (ALEA), but with the difference achieved by changing the camber of the vane relative to that of FIG. 20. The vane of FIG. 23 has a leading edge angle (LEA) that is greater than the average leading edge angle (ALEA), with the difference achieved by changing the stagger of the vane relative to that of FIG. 20. The vane of FIG. 24 also has a leading edge angle (LEA) that is greater than the average leading edge angle (ALEA), but with the difference achieved by changing the camber of the vane relative to that of FIG. 20. As mentioned above, the leading edge angles (LEA) can vary around the circumference by both stagger variation and camber variation as may be suitable for improved performance for a given design.

There are certain circumferential locations where it can be beneficial to have a greater delta in leading edge angle (DLEA) for a vane as compared to a vane in a different circumferential location. For example, there could be an installed configuration where there is a large upwards vertical velocity component acting on the engine due to airplane angle of attack and wing upwash. A vane at 0° Φ could see a larger circumferential velocity and thus swirl into the vane due to this engine-level effect. For this same condition a vane at 90° Φ may see little change in circumferential velocity and thus swirl since it is in plane with the engine vertical velocity component. To align these vanes with the upstream flow and improve performance, the vane at 0° Φ can have a larger leading edge angle (LEA) as compared to the vane at 90° Φ. Moreover, the delta in leading edge angle (DLEA) can be either zero, positive, representing an increase in leading edge angle (LEA) as compared to the average leading edge angle (DLEA), or negative, representing a decrease in leading edge angle (LEA) as compared to the average leading edge angle (DLEA).

After establishing the circumferential variation in DLEA, it may be further advantageous to change the ALEA in response to the flow angularity (“FA”) averaged over the rotor disk area. The FA can be obtained using the inverse cosine of the dot product of vectors V1 and V2. Specifically, FA=cos⁻¹(V1·V2) when the propeller is rotating clockwise when viewed FLA; and FA=180°−cos⁻¹(V1·V2) when the propeller is rotating counter-clockwise when viewed FLA. When FA is high, e.g., greater than 10 degrees, it may be beneficial to increase the ALEA.

This functionality may optionally be built into an engine control system, e.g., a full authority digital engine control (FADEC), wherein this system receives an assessment of FA from the aircraft. Such an assessment of FA could come from multiple aircraft-sensed parameters that enable a calculation or estimate of V1. For example, the aircraft could use the aircraft pitch, trajectory, sideslip, maneuver data, and wing upwash, among other variables, to compute a value for V1. Alternatively, the aircraft could provide individual inputs to the engine control system which determines the value of V1. Whether V1 is provided by the aircraft or computed by the engine control system, the engine control system may use such input to command the vane actuator or actuators to increase ALEA with or without changing DLEA for the vanes individually.

The inventors have sought to maximize efficiency of unducted open fan engines during in-flight propulsion of an aircraft. In particular, the inventors were focused on how the air flow past an unducted open fan engine can be improved. The inventors, in consideration of many different variables associated with an unducted open fan engine, considered how the vanes can be improved particularly given the different flight conditions, e.g., take-off and cruise. As described above, the inventors unexpectedly determined that varying the leading edge angles of the vanes depending upon the circumferential location of the vanes about the engine can provide benefits. More specifically, the circumferential variation in leading edge angle (LEA) could provide aircraft system benefits such as maintaining thrust at takeoff, reduced fuel burn over the mission, reduced aeromechanics risk, and/or reduced noise generation.

As shown in FIG. 25A, the delta in leading angle (DLEA) for a span along the length of the vane 42 from an average leading edge angle (ALEA) at that span for each of the plurality of vanes 42 can be disposed between an upper curve defined by the expression

$$9 * cos ( 0.8 * Φ + \frac{π}{5} ) + 7.9$$

and a lower curve defined by the expression 3.5*cos(Φ)−7.5.

As shown in FIG. 26A, the delta in leading angle (DLEA) for a span along the length of the vane 42 from an average leading edge angle (ALEA) at that span for each of the plurality of vanes 42 can be disposed between a curve between an upper curve defined by the expression

$$7 * cos ( 0.8 * Φ + \frac{π}{5} ) + 5.5$$

and a lower curve defined by the expression 5.5*cos(Φ)−4.5.

In order to take into account the installation location of the unducted fan propulsor and a resulting increased variation in swirl that the vanes need to counteract, the upper and lower bounds on the variation in the DLEA may be modified based on a dependence on the installed location of the unducted fan propulsor, expressed as a function of RL/D. Thus, the variation in the delta in the leading edge angle may be modified by a factor that depends on RL/D.

In the expression

$$9 * cos ( 0.8 * Φ + \frac{π}{5} ) + 7.9 ,$$

the value 9 corresponds to an amplitude parameter, the value 0.8 corresponds to multiplier parameter, the value π/5 corresponds to a phase shift parameter, and the value 7.9 corresponds to an adder parameter. In the expression 3.5*cos(Φ)−7.5, the value 3.5 corresponds to the amplitude parameter, the value −7.5 corresponds to the adder parameter, the phase shift parameter is set to 0, and the multiplier parameter is set 1. An expression for the upper bound for the DLEA may defined as A*(D/RL)*a*cos(m*Φ+p)+d*B*(D/RL)−(D/RL−C), where a corresponds to the amplitude parameter, m corresponds to the multiplier parameter, p corresponds to the phase shift parameter, d corresponds to the adder parameter, RL corresponds to the length of the positioning line from the quarter chord point to the point P (as defined herein), D corresponds to the maximum diameter of the rotating blades of the unducted fan propulsor, and A, B, and C are normalizing constants. Similarly, an expression for the lower bound for the DLEA may be defined as E*(D/RL)*a*cos(Φ)+d*F*(D/RL), where E and F are normalizing constants. For the more narrow range for the DLEA shown in FIG. 26A, the upper bound may be defined as G*(D/RL)*a*cos(m*Φ+p)+d*H*(D/RL)−(D/RL−C), where G and H are normalizing constants, and the lower bound may be defined as I*(D/RL)*a*cos(m*Φ+p)+d*J*(D/RL), where I and J are normalizing constants.

For example, for the broader range of variation in the DLEA shown in FIG. 25A, an upper bound may be set based on the expression

$$11.25 * ( D / RL ) * cos ( 0.8 * Φ + \frac{π}{5} ) + 9.875 * ( D / RL ) - ( D / RL - 1.25 )$$

and the lower bound may be set based on the expression 4.375*(D/RL)*cos(Φ)−9.375*(D/RL). Similarly, for the more narrow range of variation in the DLEA shown in FIG. 26A, the upper bound may be set based on the expression

$$8.75 * ( D / RL ) * cos ( 0.8 * Φ + \frac{π}{5} ) + 6.875 * ( D / RL ) - ( D / RL - 1.25 )$$

and the lower bound may be set based on the expression 6.875*(D/RL)*cos(Φ)−5.625*(D/RL).

FIG. 25B is a graph showing a third band of suitable ranges of the leading edge angle of a vane for a given Φ corresponding to the first band of FIG. 25A modified by a dependence on RL/D for RL/D=1.5. FIG. 25B shows an upper bound 2510 and a lower bound 2520 corresponding to the curves shown in FIG. 25A. FIG. 25B further shows a modified upper bound 2515, which corresponds to the upper bound 2510 modified based on RL/D, and a modified lower bound 2520, which corresponds to the lower bound 2520 modified based on RL/D.

FIG. 26B is a graph showing a fourth band of suitable ranges of the leading edge angle of a vane for a given Φ corresponding to the second band of FIG. 26A modified by a dependence on RL/D for RL/D=1.5. FIG. 26B shows an upper bound 2610 and a lower bound 2620 corresponding to the curves shown in FIG. 26A. FIG. 26B further shows a modified upper bound 2615, which corresponds to the upper bound 2610 modified based on RL/D, and a modified lower bound 2620, which corresponds to the lower bound 2620 modified based on RL/D. As shown in FIGS. 25B and 26B, for RL/D=1.5, the upper and lower bounds for the variation in the DLEA may result in a narrower band than a band based on an expression that does not depend on RL/D.

FIG. 25C is a graph showing a fifth band of suitable ranges of the leading edge angle of a vane for a given Φ corresponding to the first band of FIG. 25A modified by a dependence on RL/D for RL/D=1. FIG. 25C shows the upper bound 2510 and the lower bound 2520 corresponding to the curves shown in FIG. 25A. FIG. 25C further shows a modified upper bound 2550, which corresponds to the upper bound 2510 modified based on RL/D, and a modified lower bound 2560, which corresponds to the lower bound 2520 modified based on RL/D.

FIG. 26C is a graph showing a sixth band of suitable ranges of the leading edge angle of a vane for a given Φ corresponding to the second band of FIG. 26A modified by a dependence on RL/D for RL/D=1. FIG. 26C shows the upper bound 2610 and the lower bound 2620 corresponding to the curves shown in FIG. 26A. FIG. 26C further shows a modified upper bound 2650, which corresponds to the upper bound 2610 modified based on RL/D, and a modified lower bound 2660, which corresponds to the lower bound 2620 modified based on RL/D. As shown in FIGS. 25C and 26C, for RL/D=1, the upper and lower bounds for the variation in the DLEA may result in a wider band than a band based on an expression that does not depend on RL/D.

In any of the foregoing examples or embodiments, the unducted fan propulsor 38, incorporating the vane assembly described herein, can have a cruise flight Mach M₀ of between 0.5 and 0.9, between 0.7 and 0.9, or between 0.75 and 0.9. The unducted fan propulsor 10 can be part of a winged aircraft, such as an airplane.

Expressing thrust non-dimensionally in a way that accounts for flight speed, ambient conditions, and fan annular area yields a thrust parameter as follows:

$$\frac{{F}_{net}}{{ρ}_{0} {V}_{0}^{2} {A}_{an}} ,$$

where Fₙₑₜ is cruise fan net thrust, ρ₀ is ambient air density, V₀ is cruise flight velocity, and Aₐₙ is fan stream tube cross-sectional area at the fan inlet. Fan annular area, Aₐₙ, is computed using a maximum radius as the tip radius of the forward-most rotor blades and a minimum radius as the minimum radius of the fan stream tube entering the fan. A propulsor that operates at a high cruise fan net thrust parameter (e.g., greater than 0.06) tends to have high velocities with risk of high drag on the vanes.

Also in any of the foregoing examples or embodiments, there may be a particularly beneficial range of a dimensionless cruise fan net thrust parameter normalized by ambient density, cruise flight speed squared, and fan stream tube annular area at fan inlet that can be defined by the following expression:

$$0.15 > \frac{{F}_{net}}{{ρ}_{0} {A}_{an} {V}_{0}^{2}} > 0.06$$

A propulsor that operates at a high cruise flight Mach number (e.g., greater than 0.7) encounters velocities near the surfaces of the rotor, vanes, and nacelle that approach the speed of sound, or Mach 1.0. At such conditions, drag increases sharply with Mach number. In general, friction drag increases roughly in proportion to the square of the air velocity. However, as the Mach number increases, a larger contributor to the increase in drag comes from wave drag. Wave drag is a drag resulting from shock waves that form as the flow of air near a surface becomes supersonic (e.g., Mach>1.0). In addition to the cruise flight Mach number, another factor contributing to increased drag on a propulsor is high non-dimensional cruise fan net thrust based on fan annular area and flight speed. The same acceleration of the air stream by the fan that produces thrust also tends to increase the drag force on the rotor, vanes, and nacelle.

Both a high cruise flight Mach and high dimensionless cruise fan net thrust parameter contribute to high drag levels on the vanes. Advantageously, varying the leading edge angles of the vanes depending on the circumferential location can counter the high drag levels on the vanes when there is a high cruise flight Mach and/or a high dimensionless cruise fan net thrust parameter.

Determining the flow angularity (FA) at a rotor disk area of the open fan engine on an aircraft having at least one wing can include, as mentioned above, calculating a value for the FA using some combination of the aircraft pitch, trajectory, sideslip, maneuver data, and position and orientation of the rotor disk area relative to the wing, wherein FA=cos⁻¹(V1·V2) when the rotor is rotating clockwise forward-looking-aft (FLA) and FA=180°−cos⁻¹(V1·V2) when the rotor is rotating counter-clockwise FLA. The FA could be a simplified approximation using one of those variables, such as aircraft pitch. The FA could also use at least those variables, in addition to others.

Determining the FA can be useful for adjusting the ALEA of the vanes by changing the stagger of the vanes of the open fan engine. The stagger can be changed based upon operating conditions, e.g., cruise as opposed to take-off. For example, the stagger of the vanes can be changed to reduce flow separation on the vanes when FA>5° or, more preferably, when FA>10°. Reducing flow separation on the vanes can provide further system benefits and efficiency, such as maintaining thrust at takeoff, reduced fuel burn over the mission, reduced aeromechanics risk, and/or reduced noise generation.

Also by way of example, the stagger of the vanes can be changed from a first or initial ALEA (ALEA₁) where FA=0 to a second, different ALEA (ALEA₂) where FA>0. The change or delta in ALEA (DALEA=ALEA₂−ALEA₁) can be determined using one of the following equations:

$$0.15 ( FA - 5 deg ) <= DALEA <= ( FA = 5 deg ) \qquad Equation ( 1 )$$

$$0.25 ( FA - 5 deg ) <= DALEA <= 0.47 ( FA = 5 deg ) . \qquad Equation ( 2 )$$

These relationships between the DALEA and the FA are depicted in the graph of FIG. 35, wherein Equation (1) is depicted between the solid lines in FIG. 35 and Equation (2) is depicted between the dashed lines in FIG. 35.

As shown in FIG. 35, DALEA preferably falls between the boundary for a given FA. This depicts a desired DALEA that can result in a beneficial change in ALEA from the first or initial ALEA to second, different ALEA to reduce flow separation at the vanes. For example, flow separation at the vanes may increase with FA. To reduce flow separation at such an increased FA, an increase to ALEA can be made, such as by using the vane actuator system. The amount of increase to ALEA can be dependent upon the value of FA. As shown in FIG. 35, as the FA increases, the amount of increase to ALEA can likewise increase. Such a dynamic system can respond to the level of FA, and the amount of DLEA is dependent upon FA.

Further aspects of the disclosure are provided by the subject matter of the following clauses:

Clause 1: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

In the preceding clause, the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

In any of the preceding clauses, the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

In any of the preceding clauses, the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

In any of the preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

In any of the preceding clauses, the rotating blades diameter is between 8 to 16 feet or between 12 to 16 feet. In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.

Clause 2: An aircraft is provided including a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein 0.065<RL/D<1.98 and θ is between 187° and 340°, and wherein RL/D and θ of the P of the unducted fan propulsor adhere to the following expressions:

$$\frac{RL}{D} + \frac{( \begin{matrix}\sqrt{1.4161 * [ 1.88978 * {sin}^{2} ( θ ) - 0.0875 * {cos}^{2} ( θ ) + 0.477 * sin ( θ ) * cos ( θ ) ]} + \\ 1.764 * sin ( θ ) + 0.19146 * cos ( θ )\end{matrix} )}{1.96 * {sin}^{2} ( θ ) + 0.7225 * {cos}^{2} ( θ )} > 0 and$$

$$\frac{RL}{D} + \frac{( \begin{matrix}- \sqrt{1.4161 * [ 1.88978 * {sin}^{2} ( θ ) - 0.0875 * {cos}^{2} ( θ ) + 0.477 * sin ( θ ) * cos ( θ ) ]} + \\ 1.764 * sin ( θ ) + 0.19146 * cos ( θ )\end{matrix} )}{1.96 * {sin}^{2} ( θ ) + 0.7225 * {cos}^{2} ( θ )} < 0.$$

In the preceding clause, 0.254<RL/D<1.86 and θ is between 199° and 306°, and the P of the unducted fan propulsor is defined by the following expressions:

$$\frac{RL}{D} + \frac{( \begin{matrix}\sqrt{0.52621 * [ 0.7205 * {sin}^{2} ( θ ) - 0.352 * {cos}^{2} ( θ ) + 0.7448 * sin ( θ ) * cos ( θ ) ]} + \\ 0.8476 * sin ( θ ) + 0.23119 * cos ( θ )\end{matrix} )}{0.8649 * {sin}^{2} ( θ ) + 0.6084 * {cos}^{2} ( θ )} > 0 and$$

$$\frac{RL}{D} + \frac{( \begin{matrix}- \sqrt{0.52621 * [ 0.7205 * {sin}^{2} ( θ ) - 0.352 * {cos}^{2} ( θ ) + 0.7448 * sin ( θ ) * cos ( θ ) ]} + \\ 0.8476 * sin ( θ ) + 0.23119 * cos ( θ )\end{matrix} )}{0.8649 * {sin}^{2} ( θ ) + 0.6084 * {cos}^{2} ( θ )} < 0.$$

In any of the two preceding clauses, 0.369<RL/D<1.43 and θ is between 204° and 291°, and the P of the unducted fan propulsor is defined by the following expressions:

$$\frac{RL}{D} + \frac{( \begin{matrix}\sqrt{0.52621 * [ 0.7205 * {sin}^{2} ( θ ) - 0.352 * {cos}^{2} ( θ ) + 0.7448 * sin ( θ ) * cos ( θ ) ]} + \\ 0.8476 * sin ( θ ) + 0.23119 * cos ( θ )\end{matrix} )}{0.8649 * {sin}^{2} ( θ ) + 0.6084 * {cos}^{2} ( θ )} > 0 and$$

$$\frac{RL}{D} + \frac{( \begin{matrix}- \sqrt{0.52621 * [ 0.7205 * {sin}^{2} ( θ ) - 0.352 * {cos}^{2} ( θ ) + 0.7448 * sin ( θ ) * cos ( θ ) ]} + \\ 0.8476 * sin ( θ ) + 0.23119 * cos ( θ )\end{matrix} )}{0.8649 * {sin}^{2} ( θ ) + 0.6084 * {cos}^{2} ( θ )} < 0.$$

In any of the three preceding clauses: 0.477<RL/D<0.9455 and θ is between 211° and 274°, and the P of the unducted fan propulsor is defined by the following expressions:

$$\frac{RL}{D} + \frac{( \begin{matrix}\sqrt{0.01069156 * [ 0.036 * {sin}^{2} ( θ ) - 0.3485 * {cos}^{2} ( θ ) + 0.5418 * sin ( θ ) * cos ( θ ) ]} + \\ 0.139167 * sin ( θ ) + 0.020812 * cos ( θ )\end{matrix} )}{0.2209 * {sin}^{2} ( θ ) + 0.0484 * {cos}^{2} ( θ )} > 0 and$$

$$\frac{RL}{D} + \frac{( \begin{matrix}- \sqrt{0.01069156 * [ 0.036 * {sin}^{2} ( θ ) - 0.3485 * {cos}^{2} ( θ ) + 0.5418 * sin ( θ ) * cos ( θ ) ]} + \\ 0.139167 * sin ( θ ) + 0.020812 * cos ( θ )\end{matrix} )}{0.2209 * {sin}^{2} ( θ ) + 0.0484 * {cos}^{2} ( θ )} < 0.$$

In any of the four preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

Clause 3: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein RL/D≤2 and θ is between 187° and 342°.

In any of the preceding clauses, 0.15≤RL/D.

In any of the preceding clauses, 0.35≤RL/D, and preferably RL/D is about 0.72.

In any of the preceding clauses, wherein θ is between 198° and 310°, and preferably between 205° and 285°.

In any of the preceding clauses, the unducted fan propulsor operates at a cruise flight Mach M₀ of between 0.5 and 0.9, preferably between 0.7 and 0.9, and more preferably between 0.75 and 0.9.

In any of the preceding clauses, the unducted fan propulsor has a dimensionless cruise fan net thrust parameter expressed as follows:

$$0.15 > \frac{{F}_{net}}{{ρ}_{0} {A}_{an} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

In any of the preceding clauses, the unducted fan propulsor is undermounted to the airfoil with one or more intermediate structures.

In any of the foregoing clauses, the P of the unducted fan propulsor is variable to accommodate different operating conditions.

In any of the preceding clauses, the aircraft includes a plurality of the unducted fan propulsors.

In the preceding clause, the plurality of the unducted fan propulsors may be each mounted to the same airfoil, such as a wing or horizontal stabilizer; or the plurality of the unducted fan propulsors may be each mounted to different airfoils, such as a wing or horizontal stabilizer; or combinations thereof.

In any of the preceding clauses, wherein the unducted propulsor has two arrays of blades and only one of the array of blades is rotating.

Clause 4: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of counterclockwise rotating blades arranged in a forward array and a plurality clockwise rotating blades arranged in a rearward array, wherein one of the forward and rearward array of blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

Clause 5: An aircraft is provided that includes a fuselage; an airfoil extending from the fuselage, the airfoil having an airfoil section and the airfoil section having an effective quarter chord point (QC), and a plurality of rotating blades defining a maximum outer diameter (D); a point (P) located at an intersection of the CL and a line perpendicular to the CL that passes through a midpoint between leading and trailing edges nearest the root of one of the plurality of blades, and an ellipse origin positioning line (EOR) having a length (EORL) extending from the QC to an ellipse origin (OR) and at an angle θ measured positive in a counter-clockwise direction when the high pressure side of the airfoil section is below the airfoil section, and measured positive in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

Clause 6: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein 0.065<RL/D<1.98 and θ is between 187° and 340°; and wherein RL/D and θ of the P of the unducted fan propulsor adhere to the following expressions:

$$\frac{RL}{D} + \frac{( \begin{matrix}\sqrt{1.4161 * [ 1.88978 * {sin}^{2} ( θ ) - 0.0875 * {cos}^{2} ( θ ) + 0.477 * sin ( θ ) * cos ( θ ) ]} + \\ 1.764 * sin ( θ ) + 0.19146 * cos ( θ )\end{matrix} )}{1.96 * {sin}^{2} ( θ ) + 0.7225 * {cos}^{2} ( θ )} > 0 and$$

$$\frac{RL}{D} + \frac{( \begin{matrix}- \sqrt{1.4161 * [ 1.88978 * {sin}^{2} ( θ ) - 0.0875 * {cos}^{2} ( θ ) + 0.477 * sin ( θ ) * cos ( θ ) ]} + \\ 1.764 * sin ( θ ) + 0.19146 * cos ( θ )\end{matrix} )}{1.96 * {sin}^{2} ( θ ) + 0.7225 * {cos}^{2} ( θ )} < 0.$$

The aircraft of Clause 6, wherein:
0.254<RL/D<1.86 and θ is between 199° and 306°, and
the P of the unducted fan propulsor is defined by the following expressions:

$$\frac{RL}{D} + \frac{( \begin{matrix}\sqrt{0.52621 * [ 0.7205 * {sin}^{2} ( θ ) - 0.352 * {cos}^{2} ( θ ) + 0.7448 * sin ( θ ) * cos ( θ ) ]} + \\ 0.8476 * sin ( θ ) + 0.23119 * cos ( θ )\end{matrix} )}{0.8649 * {sin}^{2} ( θ ) + 0.6084 * {cos}^{2} ( θ )} > 0 and$$

$$\frac{RL}{D} + \frac{( \begin{matrix}- \sqrt{0.52621 * [ 0.7205 * {sin}^{2} ( θ ) - 0.352 * {cos}^{2} ( θ ) + 0.7448 * sin ( θ ) * cos ( θ ) ]} + \\ 0.8476 * sin ( θ ) + 0.23119 * cos ( θ )\end{matrix} )}{0.8649 * {sin}^{2} ( θ ) + 0.6084 * {cos}^{2} ( θ )} < 0 .$$

The aircraft of Clause 6, wherein:
0.369<RL/D<1.43 and θ is between 204° and 291°, and
the P of the unducted fan propulsor is defined by the following expressions:

$$\frac{RL}{D} + \frac{( \begin{matrix}\sqrt{0.09923 * [ 0.2964 * {sin}^{2} ( θ ) - 0.36 * {cos}^{2} ( θ ) + 0.66 * sin ( θ ) * cos ( θ ) ]} + \\ 0.3675 * sin ( θ ) + 0.0891 * cos ( θ )\end{matrix} )}{0.49 * {sin}^{2} ( θ ) + 0.2025 * {cos}^{2} ( θ )} > 0 and$$

$$\frac{RL}{D} + \frac{( \begin{matrix}- \sqrt{0.09923 * [ 0.2964 * {sin}^{2} ( θ ) - 0.36 * {cos}^{2} ( θ ) + 0.66 * sin ( θ ) * cos ( θ ) ]} + \\ 0.3675 * sin ( θ ) + 0.0891 * cos ( θ )\end{matrix} )}{0.49 * {sin}^{2} ( θ ) + 0.2025 * {cos}^{2} ( θ )} < 0 .$$

The aircraft of Clause 6, wherein:
0.477<RL/D<0.9455 and θ is between 211° and 274°, and
the P of the unducted fan propulsor is defined by the following expressions:

$$\frac{RL}{D} + \frac{( \begin{matrix}\sqrt{0.01069156 * [ 0.036 * {sin}^{2} ( θ ) - 0.3485 * {cos}^{2} ( θ ) + 0.5418 * sin ( θ ) * cos ( θ ) ]} + \\ 0.139167 * sin ( θ ) + 0.020812 * cos ( θ )\end{matrix} )}{0.2209 * {sin}^{2} ( θ ) + 0.0484 * {cos}^{2} ( θ )} > 0 and$$

$$\frac{RL}{D} + \frac{( \begin{matrix}- \sqrt{0.01069156 * [ 0.036 * {sin}^{2} ( θ ) - 0.3485 * {cos}^{2} ( θ ) + 0.5418 * sin ( θ ) * cos ( θ ) ]} + \\ 0.139167 * sin ( θ ) + 0.020812 * cos ( θ )\end{matrix} )}{0.2209 * {sin}^{2} ( θ ) + 0.0484 * {cos}^{2} ( θ )} < 0.$$

The aircraft of Clause 6, wherein the unducted fan propulsor is undermounted to the airfoil with one or more intermediate structures.

The aircraft of Clause 6, wherein the P of the unducted fan propulsor is variable to accommodate different operating conditions.

Clause 7: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein RL/D≤2 and θ is between 187° and 342°.

The aircraft of Clause 7, wherein 0.15≤RL/D.

The aircraft of Clause 7, wherein 0.35≤RL/D, and preferably RL/D is about 0.72.

The aircraft of Clause 7, wherein θ is between 198° and 310°, and preferably between 205° and 285°.

The aircraft of Clause 7, wherein the unducted fan propulsor operates at a cruise flight Mach M₀ of between 0.5 and 0.9, preferably between 0.7 and 0.9, and more preferably between 0.75 and 0.9.

The aircraft of Clause 7, wherein the unducted fan propulsor has a dimensionless cruise fan net thrust parameter expressed as follows:

$$0.15 > \frac{{F}_{net}}{{ρ}_{0} {A}_{an} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The aircraft of Clause 7, wherein the unducted fan propulsor is undermounted to the airfoil with one or more intermediate structures.

The aircraft of Clause 7, wherein the P of the unducted fan propulsor is variable to accommodate different operating conditions.

Clause 8: A method of assembly, comprising: using an aircraft body comprising a fuselage and an airfoil extending from the fuselage, wherein the airfoil has an airfoil section defining an effective quarter chord point (QC); and attaching an unducted fan propulsor to the aircraft body relative to the airfoil section on a high pressure side thereof; the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a line HP perpendicular to the axial centerline CL that passes through the axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position; wherein 0.07≤RL/D≤2.0 and θ is between 187° and 342°.

The method of Clause 8, wherein 0.15≤RL/D.

The method of Clause 8, wherein 0.35≤RL/D, and preferably RL/D is about 0.72.

The method of Clause 8, wherein θ is between 198° and 310°, and preferably between 205° and 285°.

The method of Clause 8, wherein the unducted fan propulsor operates at a cruise flight Mach M₀ of between 0.5 and 0.9, preferably between 0.7 and 0.9, and more preferably between 0.75 and 0.9.

The method of Clause 8, wherein the unducted fan propulsor has a dimensionless cruise fan net thrust parameter expressed as follows:

$$0.15 > \frac{{F}_{net}}{{ρ}_{0} {A}_{an} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The method of Clause 8, wherein the unducted fan propulsor is undermounted to the airfoil with one or more intermediate structures.

The method of Clause 8, wherein the P of the unducted fan propulsor is variable to accommodate different operating conditions.

Clause 9: A method of assembly, comprising: using an aircraft body comprising a fuselage and an airfoil extending from the fuselage, the airfoil having an airfoil section with a leading edge (LE) and a trailing edge (TE), a chord extending between the LE and TE, and an effective quarter chord point (QC) along the chord measured from the LE, wherein the airfoil has an airfoil section defining an effective quarter chord point (QC); and attaching an unducted fan propulsor to the aircraft body relative to the airfoil section on a high pressure side thereof; the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

The method of Clause 9, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The method of Clause 9, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The method of Clause 9, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

Clause 10: An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°.

Clause 11: An aircraft comprising: a fuselage; a pair of horizontal stabilizers extending relative to the fuselage, two or more unducted fan propulsors, each of the unducted fan propulsors is mounted relative to one of the horizontal stabilizers on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a clockwise direction when the high pressure side of the airfoil section is above the airfoil section when viewed looking from an outboard position towards an inboard position of the wing; wherein 0.07<RL/D≤2.0 and θ is between 187° and 342°.

In any of the preceding clauses, the unducted fan propulsor is undermounted to the airfoil, such as a wing, with one or more intermediate structures.

In any of the preceding clauses, the P of the unducted fan propulsor is variable to accommodate different operating conditions.

In any of the preceding clauses the drive mechanism may be a gas turbine engine and associated transmission to delivers torque from the drive mechanism to the propeller assembly.

In any of the preceding clauses, the unducted fan propulsor is incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9.

In any of the preceding clauses, the unducted fan propulsors is connected to the wing (or horizontal stabilizer) through a pylon.

In any of the preceding clauses, the rotating blades diameter (D) may be between 8 to 16 feet or 12 to 16 feet.

In any of the preceding clauses, each of the propulsors including a drive mechanism comprising a gas turbine engine assembly comprising in serial order a compressor, combustor, high pressure turbine and power turbine.

In any of the preceding clauses, the propulsor having a pitch angle between −5 and +5 degrees, or −3 and 0 degrees.

In any of the preceding clauses, the propulsor having an inward toe angle of between 0 and 5 degrees, or 1 and 3 degrees.

In any of the preceding clauses, the rotating blades diameter is between 8 to 16 feet or between 12 to 16 feet.

In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.

A vane assembly is provided for use with an open fan engine having a rotor with an axis of rotation and a stator, the vane assembly comprising a plurality of vanes, each arranged about the stator at a different circumferential location Φ, where Φ is measured relative to a circumferential positioning vector (CPV) defined as the cross-product of V1 and V2 (V1×V2), and θ increases in the direction of rotor rotation, each of the plurality of vanes having a vane chord (VC), and a leading edge (LE), leading edge angle (LEA) and a mean camber line (MCL) at a span of the vane, a delta in leading angle (DLEA) from an average leading edge angle (ALEA) at that span for each of the plurality of vanes being between:

$$9 * cos ( 0.8 * Φ + \frac{π}{5} ) + 7.9$$

$$and$$

$$3.5 * cos ( Φ ) - 7.5$$

wherein a first reference line (R1) at the span of the vane has a starting point (SP) at the LE and on the mean camber line (MCL) and an end point (EP) on the MCL at between 2% and 15% of the C measured from the LE; wherein a second reference line (R2) extends forward from the EP of the R1 in a direction toward the LE and parallel to the axis of rotation; and wherein the LEA is measured from the R2 to the R1 in the direction of rotor rotation.

The vane assembly of any preceding clause, wherein the ending point (EP) of the first reference line (R1) of the vanes of the plurality of vanes is located at between 2% and 10% of the vane chord (VC).

The vane assembly of any preceding clause, wherein the ending point (EP) of the first reference line (R1) of the vanes of the plurality of vanes is located at between 2% and 5% of the vane chord (VC).

The vane assembly of any preceding clause, wherein the ending point (EP) of the first reference line (R1) of the vanes of the plurality of vanes is located at between 2% and 3% of the vane chord (VC).

The vane assembly of any preceding clause, wherein the ending point (EP) of the first reference line (R1) of the vanes of the plurality of vanes is located at 2% of the vane chord (VC).

The vane assembly of any preceding clause, wherein the delta in leading edge angle (DLEA) for each of the vanes of the plurality of vanes is between:

$$7 * cos ( 0.8 * Φ + \frac{π}{5} ) + 5.5$$

$$and$$

$$5.5 * cos ( Φ ) - 4.5 .$$

The vane assembly of any preceding clause, wherein the ending point (EP) of the first reference line (R1) of the vanes of the plurality of vanes is located at between 2% and 10% of the vane chord (VC).

The vane assembly of any preceding clause, wherein the ending point (EP) of the first reference line (R1) of the vanes of the plurality of vanes is located at between 2% and 5% of the vane chord (VC).

The vane assembly of any preceding clause, wherein the ending point (EP) of the first reference line (R1) of the vanes of the plurality of vanes is located at between 2% and 3% of the vane chord (VC).

The vane assembly of any preceding clause, wherein the ending point (EP) of the first reference line (R1) of the vanes of the plurality of vanes is located at 2% of the vane chord (VC).

The vane assembly of any preceding clause, wherein the plurality of vanes includes between 8 and 16 vanes.

The vane assembly of any preceding clause, wherein the plurality of vanes includes: a vane or vanes with a maximum leading edge angle (MAXLEA), and a vane or vanes with a minimum leading edge angle (MINLEA), wherein a difference between MAXLEA and MINLEA is greater than 2 degrees.

The vane assembly of any preceding clause, wherein the difference between MAXLEA and MINLEA is greater than 3 degrees.

The vane assembly of any preceding clause, wherein the difference between MAXLEA and MINLEA is greater than 5 degrees.

The vane assembly of any preceding clause, wherein a difference in the leading edge angle (LEA) compared to the average leading edge angle (ALEA) for a given one of the plurality of vanes is due to a difference in stagger and/or camber of the given one of the plurality of vanes compared to one or more others of the plurality of vanes.

The vane assembly of any preceding clause, wherein a difference in the leading edge angle (LEA) compared to the average leading edge angle (ALEA) for a given one of the plurality of vanes is due to a difference in camber of the given one of the plurality of vanes compared to one or more others of the plurality of vanes.

The vane assembly of any preceding clause, wherein a difference in the leading edge angle (LEA) compared to the average leading edge angle (ALEA) for a given one of the plurality of vanes is due to a difference in stagger of the given one of the plurality of vanes compared to one or more others of the plurality of vanes.

An open fan engine is provided that has a rotor with an axis of rotation and a stator, the rotor having a plurality of blades disposed about a periphery thereof and the stator comprising the vane assembly of any of the preceding clauses.

An aircraft is provided having the open fan engine of the preceding clause, wherein the open fan engine has a cruise Mach M₀ of between 0.5 and 0.9, preferably between 0.7 and 0.9, and more preferably between 0.75 and 0.9.

An aircraft is provided having the open fan engine of any of the preceding two clauses, wherein the open fan engine has a dimensionless cruise fan net thrust parameter expressed as follows:

$$0.15 > \frac{{F}_{net}}{{ρ}_{0} {A}_{an} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation RAR.

The vane assembly of any preceding clause, wherein the DLEA of at least 50% of the vanes is between:

$$9 * cos ( 0.8 * Φ + \frac{π}{5} ) + 7.9$$

$$and$$

$$3.5 * cos ( Φ ) - 7.5 .$$

A method is provided of reducing flow separation on the vanes of the vane assembly of the open fan engine of any of the preceding claims, the open fan engine being in combination with an aircraft having at least one wing, the method including: determining the flow angularity (FA) by combining two or more of aircraft pitch, trajectory, sideslip, maneuver data, position and orientation of the rotor disk area relative to the wing, and wing circulation, wherein FA=cos⁻¹ (V1·V2) when the rotor is rotating clockwise forward-looking-aft (FLA) and FA=180°−cos⁻¹(V1·V2) when the rotor is rotating counter-clockwise FLA; and increasing the ALEA of the vanes of the vane assembly by changing the stagger of the vanes as a function of the FA.

A method is provided of reducing flow separation on the vanes of the vane assembly of the open fan engine of any of the preceding claims, the open fan engine being in combination with an aircraft having at least one wing, the method including: determining the flow angularity (FA) by combining two or more of aircraft pitch, trajectory, sideslip, maneuver data, and position and orientation of the rotor disk area relative to the wing, wherein FA=cos⁻¹(V1·V2) when the rotor is rotating clockwise forward-looking-aft (FLA) and FA=180°−cos⁻¹(V1·V2) when the rotor is rotating counter-clockwise FLA; and changing the ALEA of the vanes by changing the stagger of the vanes to reduce flow separation on the vanes when FA>5°.

Any of the preceding methods may further include changing the ALEA of the vanes by changing the stagger of the vanes to reduce flow separation on the vanes when FA>10°.

Any of the preceding methods may further include changing the ALEA of the vanes by changing the stagger of the vanes from a first ALEA (ALEA₁) where FA=0 to a second (ALEA₂) where FA>5, where the delta in ALEA (DALEA) between ALEA₂ and ALEA₁ is greater than or equal to 0.15 (FA−5°) and less than or equal to (FA−5°).

Any of the preceding methods may further include the ALEA of the vanes by changing the stagger of the vanes from a first ALEA (ALEA₁) where FA=0 to a second (ALEA₂) where FA>5, where the delta in ALEA (DALEA) between ALEA₂ and ALEA₁ is greater than or equal to 0.25*(FA−5°) and less than or equal to 0.7*(FA−5°).

The vane assembly of any preceding clause, wherein the distribution of DLEA as compared to ¢ is adjustable.

The vane assembly of any preceding clause, wherein the difference between MAXLEA and MINLEA increases with increasing ALEA.

The vane assembly of any preceding clause, further including a vane actuator system, each of the vanes being mounted to a rotatable trunnion, each of the rotatable trunnions being rotatable via a linkage arm extending between the trunnion and a kinematic linkage, wherein the change in MAXLEA and MINLEA as ALEA varies is achieved by using multiple linkage lengths between the vane trunnion and kinematic system.

The vane assembly of any preceding clause, wherein V1 is a vector of unit magnitude aligned to the flight direction extending from upstream to downstream.

The vane assembly of any preceding clause, wherein V1 is a vector of unit magnitude and represents the average flow direction integrated over the disk area of the intended rotor location as it would be positioned on an aircraft.

A vane assembly is provided for use with an open fan engine having a rotor with a rotor axis of rotation (RAR) and a stator, the vane assembly comprising a plurality of vanes, each arranged about the stator at a different circumferential location θ, where θ is measured relating to a circumferential positioning vector (CPV) defined as a line that extends from the RAR horizontally to the left when forward looking aft (FLA) for clockwise rotor rotation FLA and continuing in the direction of rotation and starting from a line that extends from the RAR horizontally to the right when FLA for counter-clockwise rotation FLA and continuing in the direction of rotation, each of the plurality of vanes having a vane chord (VC), and a leading edge (LE), leading edge angle (LEA) and a mean camber line (MCL) at a span of the vane, a delta in leading angle (DLEA) from an average leading edge angle (ALEA) at that span for each of the plurality of vanes being between: 9*cos(0.8*Φ+π/5)+7.9 and 3.5*cos(Φ)−7.5; wherein a first reference line (R1) at the span of the vane has a starting point (SP) at the LE and on the mean camber line (MCL) and an end point (EP) on the MCL at between 2% and 15% of the C measured from the LE; wherein a second reference line (R2) extends forward from the EP of the R1 in a direction toward the LE and parallel to the axis of rotation; and wherein the LEA is measured from the R2 to the R1 in the direction of rotor rotation. This clause may be combined with any of the preceding clauses.

An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°; wherein the plurality of blades includes a vane assembly comprising a plurality of vanes, each arranged about a stator at a different circumferential location Φ, where Φ is measured relative to a circumferential positioning vector (CPV) defined as the cross-product of V1 and V2 (V1×V2), and Φ increases in the direction of rotor rotation of a rotor of the unducted fan propulsor, each of the plurality of vanes having a vane chord (VC), and a leading edge (LE), leading edge angle (LEA) and a mean camber line (MCL) at a span of the vane, a delta in leading angle (DLEA) from an average leading edge angle (ALEA) at that span for each of the plurality of vanes being between: 9*cos (0.8*+)+7.9 and 3.5*cos( )−7.5; wherein a first reference line (R1) at the span of the vane has a starting point (SP) at the LE and on the mean camber line (MCL) and an end point (EP) on the MCL at between 2% and 15% of the VC measured from the LE; wherein a second reference line (R2) extends forward from the EP of the R1 in a direction toward the LE and parallel to the axis of rotation; and wherein the LEA is measured from the R2 to the R1 in the direction of rotor rotation.

The aircraft of the preceding clause, wherein 0.15≤RL/D.

The aircraft of any of the two preceding clauses, wherein the end point (EP) of the first reference line (R1) of the vanes of the plurality of vanes is located at between 2% and 10% of the vane chord (VC).

The aircraft of any of the three preceding clauses, wherein θ is between 198° and 310°, and preferably between 205° and 285°.

The aircraft of any of the four preceding clauses, wherein the two or more unducted fan propulsors are configured to operate at a cruise flight Mach M0 of between 0.7 and 0.9, and more preferably between 0.75 and 0.9; or the two or more unducted fan propulsors are configured to propel the aircraft at a cruise flight Mach M0 of between 0.7 and 0.9, and more preferably between 0.75 and 0.85.

The aircraft of any of the five preceding clauses, wherein the unducted fan propulsor has a dimensionless cruise fan net thrust parameter expressed as follows: 0.15>6, wherein is cruise fan net thrust, is ambient air density, is cruise flight velocity, and is annular cross-sectional area perpendicular to an axis of rotation of a rotor axis of rotation.

The aircraft of any of the six preceding clauses, wherein the plurality of vanes comprises: a vane or vanes with a maximum leading edge angle (MAXLEA), and a vane or vanes with a minimum leading edge angle (MINLEA), wherein a difference between MAXLEA and MINLEA is greater than 2 degrees.

The aircraft of any of the seven preceding clauses, wherein a difference in the leading edge angle (LEA) compared to the average leading edge angle (ALEA) for a given one of the plurality of vanes is due to a difference in stagger and/or camber of the given one of the plurality of vanes compared to one or more others of the plurality of vanes.

The aircraft of any of the eight preceding clauses, wherein the DLEA from the ALEA at that span for each of the of vanes plurality being between: 11.25*(D/RL)*cos(0.8*+)+9.875*(D/RL)−(D/RL−1.25) and 4.375*(D/RL)*cos( )−9.375*(D/RL).

The aircraft of any of the nine preceding clauses, wherein the DLEA from the ALEA at that span for each of the plurality of vanes being between: 7*cos(0.8*+)+5.5 and 5.5*cos( )−4.5.

The aircraft of any of the ten preceding clauses, wherein the DLEA from the ALEA at that span for each of the plurality of vanes being between: 8.75*(D/RL)*cos(0.8*+)+6.875*(D/RL)−(D/RL−1.25) and 6.875*(D/RL)*cos( )−5.625*(D/RL).

The aircraft of any of the nine preceding clauses, wherein V1 is a vector of unit magnitude aligned to a flight direction extending from upstream to downstream.

An aircraft, comprising: a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7; wherein the plurality of blades includes a vane assembly comprising a plurality of vanes, each arranged about a stator at a different circumferential location Φ, where Φ is measured relative to a circumferential positioning vector (CPV) defined as the cross-product of V1 and V2 (V1×V2), and Φ increases in the direction of rotor rotation of a rotor of the unducted fan propulsor, each of the plurality of vanes having a vane chord (VC), and a leading edge (LE), leading edge angle (LEA) and a mean camber line (MCL) at a span of the vane, a delta in leading angle (DLEA) from an average leading edge angle (ALEA) at that span for each of the plurality of vanes being between: 9*cos(0.8*+)+7.9 and 3.5*cos( )−7.5; wherein a first reference line (R1) at the span of the vane has a starting point (SP) at the LE and on the mean camber line (MCL) and an end point (EP) on the MCL at between 2% and 15% of the VC measured from the LE; wherein a second reference line (R2) extends forward from the EP of the R1 in a direction toward the LE and parallel to the axis of rotation; and wherein the LEA is measured from the R2 to the R1 in the direction of rotor rotation.

The aircraft of the preceding clause, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The aircraft of any of the two preceding clauses, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The aircraft of any of the three preceding clauses, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

The aircraft of any of the four preceding clauses, wherein the DLEA from the ALEA the at that span for each of plurality of vanes being between: 11.25*(D/RL)*cos(0.8*+)+9.875*(D/RL)−(D/RL−1.25) and 4.375*(D/RL)*cos( )−9.375*(D/RL).

The aircraft of any of the five preceding clauses, wherein the DLEA from the ALEA at that span for each of the plurality of vanes being between: 7*cos(0.8*+)+5.5 and 5.5*cos( )−4.5.

The aircraft of any of the six preceding clauses, wherein the DLEA from the ALEA at that span for each of the plurality of vanes being between: 8.75*(D/RL)*cos(0.8*+)+6.875*(D/RL)−(D/RL−1.25) and 6.875*(D/RL)*cos( )−5.625*(D/RL).

The aircraft of any of the seven preceding clauses, wherein V1 is a vector of unit magnitude aligned to a flight direction extending from upstream to downstream.

An aircraft, comprising: a fuselage; an airfoil extending from the fuselage, the airfoil having an airfoil section defining an effective quarter-chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:

$$\frac{RL}{D} + \frac{\begin{matrix}( \sqrt{1.4161 * [ 1.88978 * {sin}^{2} ( θ ) - 0.0875 * {cos}^{2} ( θ ) + 0.477 * sin ( θ ) * cos ( θ ) ]} + \\ 1.764 * sin ( θ ) + 0.19146 * cos ( θ ) )\end{matrix}}{1.96 * {sin}^{2} ( θ ) + 0.7225 * {cos}^{2} ( θ )} > 0$$

$$and$$

$$\frac{RL}{D} + \frac{\begin{matrix}( - \sqrt{1.4161 * [ 1.88978 * {sin}^{2} ( θ ) - 0.0875 * {cos}^{2} ( θ ) + 0.477 * sin ( θ ) * cos ( θ ) ]} + \\ 1.764 * sin ( θ ) + 0.19146 * cos ( θ ) )\end{matrix}}{1.96 * {sin}^{2} ( θ ) + 0.7225 * {cos}^{2} ( θ )} < 0 ;$$

wherein the plurality of blades includes a vane assembly comprising a plurality of vanes, each arranged about a stator at a different circumferential location Φ, where Φ is measured relative to a circumferential positioning vector (CPV) defined as the cross-product of V1 and V2 (V1×V2), and Φ increases in the direction of rotor rotation of a rotor of the unducted fan propulsor, each of the plurality of vanes having a vane chord (VC), and a leading edge (LE), leading edge angle (LEA) and a mean camber line (MCL) at a span of the vane, a delta in leading angle (DLEA) from an average leading edge angle (ALEA) at that span for each of the plurality of vanes being between: 9*cos (0.8*+)+7.9 and 3.5*cos( )−7.5; wherein a first reference line (R1) at the span of the vane has a starting point (SP) at the LE and on the mean camber line (MCL) and an end point (EP) on the MCL at between 2% and 15% of the VC measured from the LE; wherein a second reference line (R2) extends forward from the EP of the R1 in a direction toward the LE and parallel to the axis of rotation; and wherein the LEA is measured from the R2 to the R1 in the direction of rotor rotation.

The aircraft of the preceding clause, wherein V1 is a vector of unit magnitude aligned to a flight direction extending from upstream to downstream.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An aircraft comprising:
a fuselage;
a pair of wings extending from the fuselage,
two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an airfoil section having an effective quarter chord point QC;
a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°;
wherein the plurality of blades includes a vane assembly comprising a plurality of vanes, each arranged about a stator at a different circumferential location Φ, where Φ is measured relative to a circumferential positioning vector (CPV) defined as the cross-product of V1 and V2 (V1×V2), and Φ increases in the direction of rotor rotation of a rotor of the unducted fan propulsor, each of the plurality of vanes having a vane chord (VC), and a leading edge (LE), leading edge angle (LEA) and a mean camber line (MCL) at a span of the vane, a delta in leading angle (DLEA) from an average leading edge angle (ALEA) at that span for each of the plurality of vanes being between:
$$9 * cos ( 0.8 * Φ + \frac{π}{5} ) + 7.9$$
$$and$$
$$3.5 * cos ( Φ ) - 7.5 ;$$
wherein a first reference line (R1) at the span of the vane has a starting point (SP) at the LE and on the mean camber line (MCL) and an end point (EP) on the MCL at between 2% and 15% of the VC measured from the LE;
wherein a second reference line (R2) extends forward from the EP of the R1 in a direction toward the LE and parallel to the axis of rotation; and
wherein the LEA is measured from the R2 to the R1 in the direction of rotor rotation.

2. The aircraft of claim 1, wherein 0.15≤RL/D.

3. The aircraft of claim 1, wherein the end point (EP) of the first reference line (R1) of the vanes of the plurality of vanes is located at between 2% and 10% of the vane chord (VC).

4. The aircraft of claim 1, wherein V1 is a vector of unit magnitude aligned to a flight direction extending from upstream to downstream.

5. The aircraft of claim 1, wherein the two or more unducted fan propulsors are configured to operate at a cruise flight Mach M₀ of between 0.7 and 0.9, and more preferably between 0.75 and 0.9; or the two or more unducted fan propulsors are configured to propel the aircraft at a cruise flight Mach M₀ of between 0.7 and 0.9, and more preferably between 0.75 and 0.85.

6. The aircraft of claim 1, wherein the plurality of vanes comprises:
a vane or vanes with a maximum leading edge angle (MAXLEA), and
a vane or vanes with a minimum leading edge angle (MINLEA),
wherein a difference between MAXLEA and MINLEA is greater than 2 degrees.

7. The aircraft of claim 1, wherein a difference in the leading edge angle (LEA) compared to the average leading edge angle (ALEA) for a given one of the plurality of vanes is due to a difference in stagger and/or camber of the given one of the plurality of vanes compared to one or more others of the plurality of vanes.

8. The aircraft of claim 1, wherein the DLEA from the ALEA at that span for each of the plurality of vanes being between:
$$11.25 * ( D / RL ) * cos ( 0.8 * Φ + \frac{π}{5} ) + 9.875 * ( D / RL ) - ( D / RL - 1.25 )$$
$$and$$
$$4. 375 * ( D / RL ) * cos ( Φ ) - 9.375 * ( D / RL ) .$$

9. The aircraft of claim 1, wherein the DLEA from the ALEA at that span for each of the plurality of vanes being between:
$$7 * cos ( 0.8 * Φ + \frac{π}{5} ) + 5.5$$
$$and$$
$$5.5 * cos ( Φ ) - 4.5 .$$

10. The aircraft of claim 1, wherein the DLEA from the ALEA at that span for each of the plurality of vanes being between:
$$8.75 * ( D / RL ) * cos ( 0.8 * Φ + \frac{π}{5} ) + 6.875 * ( D / RL ) - ( D / RL - 1.25 )$$
$$and$$
$$6.875 * ( D / RL ) * cos ( Φ ) - 5.625 * ( D / RL ) .$$

11. An aircraft, comprising:
a fuselage;
an airfoil extending from the fuselage, the airfoil having an airfoil section defining an effective quarter chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7;
wherein the plurality of blades includes a vane assembly comprising a plurality of vanes, each arranged about a stator at a different circumferential location Φ, where Φ is measured relative to a circumferential positioning vector (CPV) defined as the cross-product of V1 and V2 (V1×V2), and Φ increases in the direction of rotor rotation of a rotor of the unducted fan propulsor, each of the plurality of vanes having a vane chord (VC), and a leading edge (LE), leading edge angle (LEA) and a mean camber line (MCL) at a span of the vane, a delta in leading angle (DLEA) from an average leading edge angle (ALEA) at that span for each of the plurality of vanes being between:
$$9 * cos ( 0.8 * Φ + \frac{π}{5} ) + 7.9$$
$$and$$
$$3.5 * cos ( Φ ) - 7.5 ;$$
wherein a first reference line (R1) at the span of the vane has a starting point (SP) at the LE and on the mean camber line (MCL) and an end point (EP) on the MCL at between 2% and 15% of the VC measured from the LE;
wherein a second reference line (R2) extends forward from the EP of the R1 in a direction toward the LE and parallel to the axis of rotation; and
wherein the LEA is measured from the R2 to the R1 in the direction of rotor rotation.

12. The aircraft of claim 11, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

13. The aircraft of claim 11, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

14. The aircraft of claim 11, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

15. The aircraft of claim 11, wherein the DLEA from the ALEA at that span for each of the plurality of vanes being between:
$$11.25 * ( D / RL ) * cos ( 0.8 * Φ + \frac{π}{5} ) + 9.875 * ( D / RL ) - ( D / RL - 1.25 )$$
$$and$$
$$4.375 * ( D / RL ) * cos ( Φ ) - 9.375 * ( D / RL ) .$$

16. The aircraft of claim 11, wherein the DLEA from the ALEA at that span for each of the plurality of vanes being between:
$$7 * cos ( 0.8 * Φ + \frac{π}{5} ) + 5.5$$
$$and$$
$$5.5 * cos ( Φ ) - 4.5 .$$

17. The aircraft of claim 11, wherein the DLEA from the ALEA at that span for each of the plurality of vanes being between:
$$8.75 * ( D / RL ) * cos ( 0.8 * Φ + \frac{π}{5} ) + 6.875 * ( D / RL ) - ( D / RL - 1.25 )$$
$$and$$
$$6.875 * ( D / RL ) * cos ( Φ ) - 5.625 * ( D / RL ) .$$

18. The aircraft of claim 11, wherein V1 is a vector of unit magnitude aligned to a flight direction extending from upstream to downstream.

19. An aircraft, comprising:
a fuselage;
an airfoil extending from the fuselage, the airfoil having an airfoil section defining an effective quarter-chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:
$$\frac{RL}{D} + \frac{\begin{matrix}( \sqrt{1.4161 * [ 1.88978 * {sin}^{2} ( θ ) - 0.0875 * {cos}^{2} ( θ ) + 0.477 * sin ( θ ) * cos ( θ ) ]} + \\ 1.764 * sin ( θ ) + 0.19146 * cos ( θ ) )\end{matrix}}{1.96 * {sin}^{2} ( θ ) + 0.7225 * {cos}^{2} ( θ )} > 0$$
$$and$$
$$\frac{RL}{D} + \frac{\begin{matrix}( - \sqrt{1.4161 * [ 1.88978 * {sin}^{2} ( θ ) - 0.0875 * {cos}^{2} ( θ ) + 0.477 * sin ( θ ) * cos ( θ ) ]} + \\ 1.764 * sin ( θ ) + 0.19146 * cos ( θ ) )\end{matrix}}{1.96 * {sin}^{2} ( θ ) + 0.7225 * {cos}^{2} ( θ )} < 0 ;$$
wherein the plurality of blades includes a vane assembly comprising a plurality of vanes, each arranged about a stator at a different circumferential location Φ, where Φ is measured relative to a circumferential positioning vector (CPV) defined as the cross-product of V1 and V2 (V1×V2), and Φ increases in the direction of rotor rotation of a rotor of the unducted fan propulsor, each of the plurality of vanes having a vane chord (VC), and a leading edge (LE), leading edge angle (LEA) and a mean camber line (MCL) at a span of the vane, a delta in leading angle (DLEA) from an average leading edge angle (ALEA) at that span for each of the plurality of vanes being between:
$$9 * cos ( 0.8 * Φ + \frac{π}{5} ) + 7.9$$
$$and$$
$$3.5 * cos ( Φ ) - 7.5 ;$$
wherein a first reference line (R1) at the span of the vane has a starting point (SP) at the LE and on the mean camber line (MCL) and an end point (EP) on the MCL at between 2% and 15% of the VC measured from the LE;
wherein a second reference line (R2) extends forward from the EP of the R1 in a direction toward the LE and parallel to the axis of rotation; and
wherein the LEA is measured from the R2 to the R1 in the direction of rotor rotation.

20. The aircraft of claim 19, wherein V1 is a vector of unit magnitude aligned to a flight direction extending from upstream to downstream.
